(19) United States
(12) Patent Application Publication
(10) Pub. No.: US 2023/0382694 A1
(43) Pub. Date: Nov. 30, 2023

(54) CRANE TELESCOPING BOOM, SYSTEM AND METHOD FOR ACTUATING CRANE TELESCOPING BOOM

(71) Applicant: MANITOWOC CRANE COMPANIES, LLC, Milwaukee, WI (US)

(72) Inventor: Stephen J. SCHOONMAKER, Chambersburg, PA (US)

(21) Appl. No.: 18/324,892

(22) Filed: May 26, 2023

Related U.S. Application Data
(60) Provisional application No. 63/346,319, filed on May 27, 2022.

(51) Int. Cl. B66C 13/48; B66C 23/70; B66C 23/42

(52) U.S. Cl. CPC B66C 13/48; B66C 23/706; B66C 23/42; B66C 2700/0371

(57) ABSTRACT

A crane has telescoping boom, a boom actuator system and a control system. The telescoping boom includes base section and telescoping sections. The boom actuator system includes a telescoping member and a locking head on the telescoping member, the locking head having pinning members configured to selectively interact with the telescoping sections. The control system is configured to receive parameter information relating to the boom actuator system and control the boom actuator system to perform an actuator operation using the parameter information. The actuator operation is performed to move a pinning member to a selected position. The control system is further configured to determine whether the pinning member is in the selected position using the parameter information, and to control the boom actuator system to perform an actuator operation to adjust the telescoping member if the control system determines the pinning member is not in the selected position.

### FIELD

The following description relates generally to a telescoping boom of a crane, such as a pinned telescoping boom, and systems and methods for actuating the telescoping boom.

### BACKGROUND

A crane telescoping boom includes boom sections selectively movable to extend or retract relative to an adjacent boom section in a telescoping manner. Such movements allow for the length of the telescoping boom to be selectively increased by extending a boom section and decreased by retracting a boom section.

In a known boom, a hydraulic rod-cylinder device includes a pinning head having coupling pins and locking pins. The coupling pins are operable to engage with and disengage from a selected boom section, thereby coupling and uncoupling, respectively, the hydraulic rod-cylinder device to the boom section. The locking pins are operable to unlock a boom section from, and lock a boom section to, an adjacent boom section, to permit and restrict, respectively, relative telescoping movement of the boom section.

Movements of the coupling pins to engage with and disengage from a boom section, and movement of the locking pins to unlock a boom section and lock the boom section to an adjacent boom section, are controlled by a hydraulic “trombone tube” arrangement connected to the hydraulic rod-cylinder device.

However, operations of the hydraulic trombone tube may vary with entrained air and cold temperatures, which can make corresponding operations of the coupling pins and/or locking pins unpredictable. In addition, pressure in the trombone tube may cause movement of the rod-cylinder cylinder device which, in turn, can cause inaccurate positioning of the coupling pins and locking pins relative to a boom section. As a result, operations of the coupling pins and/or the locking pins may not be completed due to inaccurate positioning, and/or movements of the coupling pins and/or locking pins may be restricted, for example, by an impingement with a boom section due to a misalignment.

Electric actuators have been proposed for operating coupling pins and locking pins. While electric actuators may address some challenges related to the hydraulic trombone tube, challenges remain with respect to proper positioning of the pins relative to the telescopically arranged sections. As a result, intended movements of the pins may still be obstructed at times. Attempts to free the pins for intended movements have resulted in mechanically complex arrangements, may require operator intervention or action, and may result in crane downtime.

### SUMMARY

It may be desirable to provide a pinned telescoping boom in which pinning and locking operations may be performed automatically and corrective actions can be taken without operator intervention. A telescoping boom with such features may reduce downtime, system wear and system maintenance, and further, may reduce time needed to perform boom extend and retract operations.

According to one aspect, a crane includes a carrier and a superstructure mounted on the carrier, the superstructure including a telescoping boom having a base section and a plurality of telescoping sections. The crane further includes a boom actuator system having a telescoping member and a locking head on the telescoping member, the locking head having pinning members configured to selectively interact with the telescoping sections. A control system is configured to receive parameter information relating to the boom actuator system and to control the boom actuator system to perform an actuator operation using the parameter information to move a pinning member to a selected position. The control system is configured to determine whether the pinning member is in the selected position corresponding to the actuator operation using the parameter information. The control system is configured to control the boom actuator system to perform an actuator operation to adjust the telescoping member in the length direction if the control system determines that the pinning member is not in the selected position.

According to another aspect, a boom actuator system includes a telescoping member configured for telescoping movement to extend and retract in a length direction, a locking head on the telescoping member, the locking head having pinning members configured to selectively interact with telescoping sections of a telescoping boom, a first electric actuator having a first drive arm movable in response to operation of the first electric actuator to perform an actuator operation, and an operating plate movable relative to the locking head along a movement axis. The operating plate is configured to interact with the pinning member such that movement of the operating plate along the movement axis causes movement of the pinning member. The operating plate is operably coupled to first drive arm and is movable along the movement axis in response to movement of the first drive arm. A control system is configured to receive parameter information relating to first electric actuator and to control the first electric actuator to perform the actuator operation to move a pinning member of the pinning members to a selected position. The control system is configured to determine whether the pinning member is in the selected position using the parameter information, and to control the telescoping member to perform an actuator operation to adjust the position of the locking head in the length direction if the control system determines that the pinning member is not in the selected position.

According to still another aspect, a control system is configured to control a boom actuator system to perform an actuator operation, the boom actuator system having a telescoping member and a locking head on the telescoping member, the locking head having pinning members configured to selectively interact with telescoping sections of a telescoping boom. The control system includes a processor and a memory configured to store program instructions which when executed by the processor cause the control system to: receive parameter information relating to parameters of the boom actuator system, provide a control signal to the boom actuator system to control the boom actuator system to perform an actuator operation to move a pinning member to a selected position using the parameter information, determine whether the pinning member is in the selected position using the parameter information, and control the boom actuator system to perform an actuator operation to adjust the telescoping member in the length direction if the pinning member is not in the selected position.

These and other features and advantages of the present invention will be apparent from the following detailed description, in conjunction with the appended claims.

### BRIEF DESCRIPTION OF THE DRAWINGS

FIG. 1 is a side view of a crane according to an embodiment;

FIG. 2 is a top view of the crane of FIG. 1;

FIG. 3 is a cross sectional view showing an example of a telescoping boom of the crane of FIG. 1;

FIG. 4A is an enlarged view of a portion of the telescoping boom of FIG. 3;

FIG. 4B is an enlarged view of a portion of the telescoping boom of FIG. 4A with a boom actuator system removed for clarity;

FIG. 5 is a first perspective view showing an example of a boom actuator system of the crane of FIG. 1;

FIG. 6A is a diagram showing an example of an operating plate of the boom actuator system of FIG. 5;

FIGS. 6B-6D are diagrams showing examples of various movements of the operating plate of FIG. 6A;

FIG. 7 is a side view of the boom actuator system of the crane of FIG. 1;

FIG. 8 is a second perspective view of the boom actuator system of FIG. 5;

FIG. 9 is a third perspective view of the boom actuator system of FIG. 5;

FIG. 10 is a schematic block diagram showing an example of a control system of the crane of FIG. 1;

FIG. 11 is a schematic block diagram showing an example of a memory of the control system of FIG. 10;

FIG. 12 is a schematic block diagram showing an example of the user interface of the control system of FIG. 10;

FIG. 13 is a schematic block diagram showing examples of relationships between various crane components, parameters, sensors, parameter information and the control system;

FIG. 14 is a schematic block diagram showing an example of the parameter information stored in the memory of FIG. 11;

FIG. 15 is schematic diagram showing examples of the control system, sensors and boom actuator system;

FIG. 16 is a schematic block diagram showing examples of control signals and actuator operations; and

FIG. 17 is a diagram showing examples of an output device of the control system of FIG. 10.

### DETAILED DESCRIPTION

While the present device is susceptible of embodiment in various forms, there is shown in the figures and will hereinafter be described a presently preferred embodiment with the understanding that the present disclosure is to be considered an exemplification of the device and is not intended to be limited to the specific embodiment illustrated.

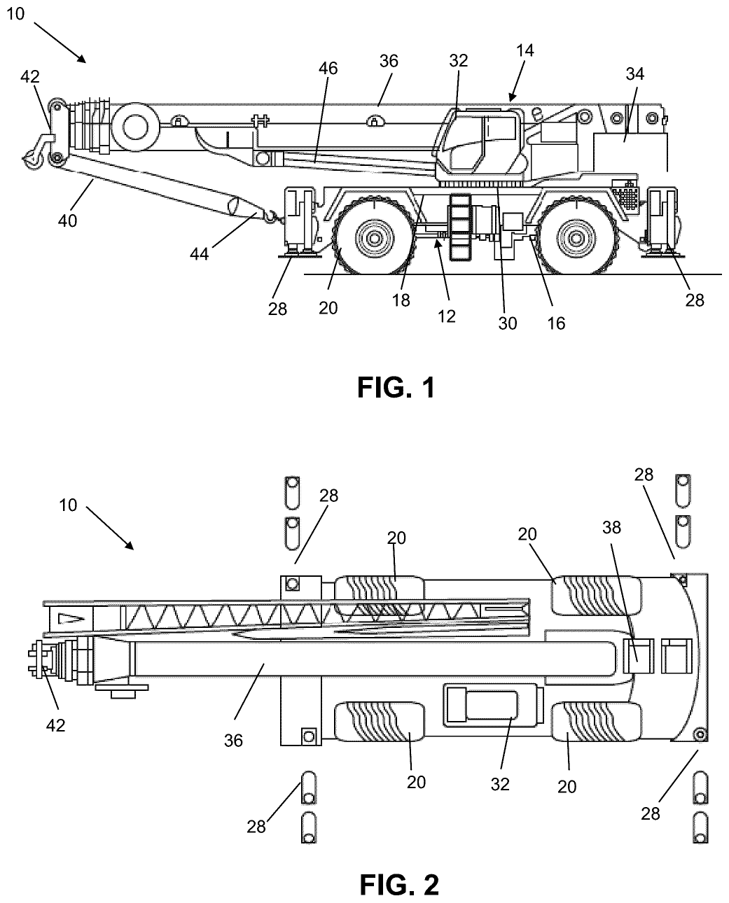

With reference to FIGS. 1 and 2, a crane 10 generally includes a carrier 12 and a superstructure 14. The carrier 12 includes a chassis 16, a carrier deck 18 supported on the chassis 16, a plurality of wheels 20 connected to the chassis 16, for example, by a suspension system (not shown), and a powertrain (not shown) configured to deliver power to the wheels 20.

The carrier 12 may also include one or more outriggers 28. The outriggers 28 may be deployed to a selected horizontal distance and engage the ground, directly or indirectly, to support the crane 10 in a lifting operation. The outriggers 28 may be retracted (i.e., not deployed) such that the crane 10 is supported on the wheels 20 for self-propelled movement.

The carrier 12 further includes a rotating bed 30 (also referred to as a turntable) mounted on an upper surface of the chassis 16. A bearing assembly (not shown) is interposed between the rotating bed 30 and a bearing surface of the chassis 16. The rotating bed 30 is configured to rotate on a vertical axis (not shown).

The crane 12 also includes a hydraulic system (not shown) configured to operate various hydraulically powered crane components. The hydraulic system includes various known hydraulic components, such as one or more hydraulic pumps, hydraulic lines, valves, hydraulic motors, controllers, and the like.

The superstructure 14 is arranged on the rotating bed 30 and thus, is configured to rotate relative to the carrier 12 in first and second rotational directions with corresponding rotation of the rotating bed 30. The superstructure 14 includes, for example, an operator's cab 32, a counterweight assembly 34, a telescoping boom 36, and one or more hoists 38 operable to wind and unwind a rope 40. The rope 40 may extend generally along a length of telescoping boom 36 to be suspended from a distal end 42 (also referred to as a boom nose) of the telescoping boom 36. The suspended portion of the rope 40 can be connected to a lift appliance 44, such as a hook block, configured to engage a load or load carrier.

The superstructure 14 also includes a derricking cylinder 46 connected between the telescoping boom 36 and the rotating bed 30. The derricking cylinder 46 is operable to lift and lower the telescoping boom 36 through a range of lift angles.

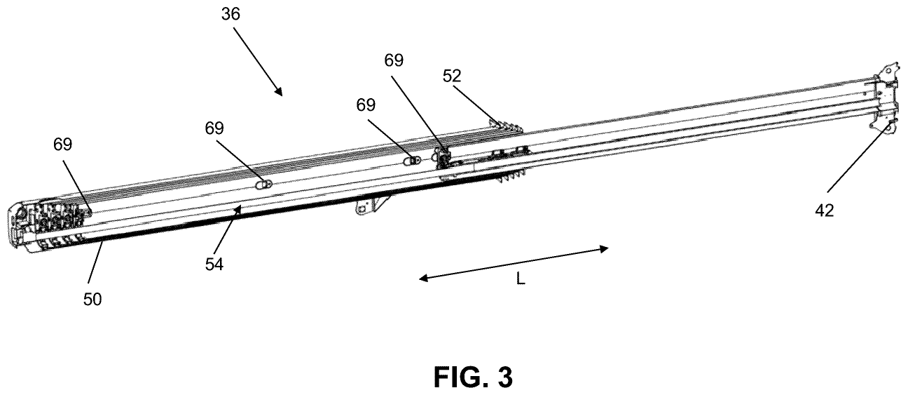

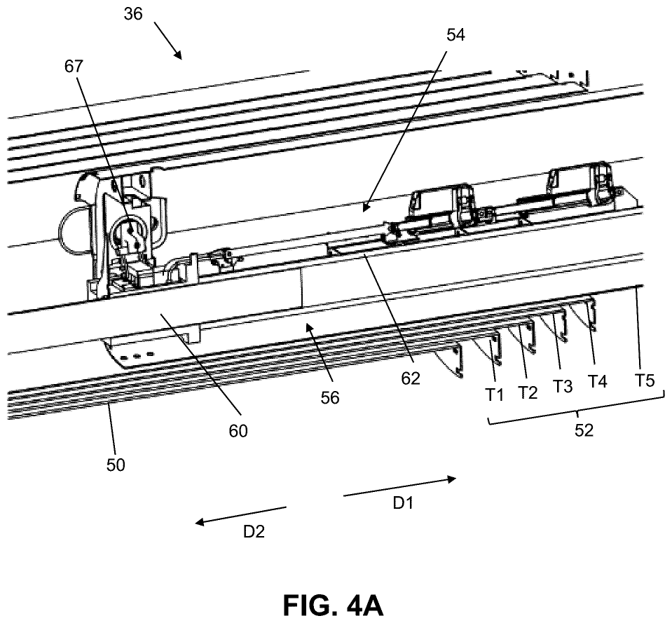

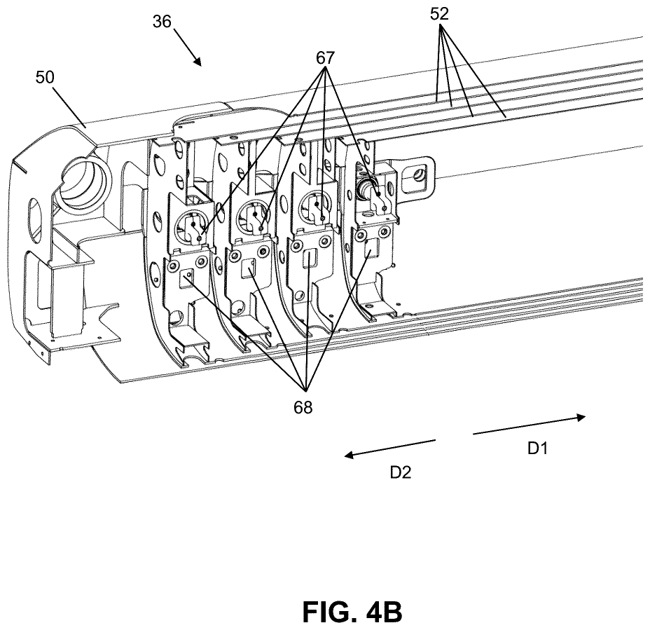

With additional reference to FIGS. 3 and 4, the telescoping boom 36 includes a plurality of boom sections, including a base section 50 and a plurality of telescoping sections 52 retractable into and extendable from the base section 50. The telescoping sections 52 may be arranged in a nested configuration, such that each successive telescoping section 52 has a width smaller than the width of the immediately outward adjacent section. In this manner, each telescoping section 52 is extendable and retractable relative to the immediately outward adjacent boom section in a telescoping movement. In the illustrated example, the telescoping boom 36 is provided with five telescoping sections T1, T2, T3, T4, T5, wherein the T1 section is the section having the greatest width and is immediately adjacent to the base section 50. The T5 section is the section having the smallest width and is the inner most section in a cross-sectional view of the telescoping boom 36. The T5 section includes the boom nose 42 and thus, is the farthest extending section of the telescoping boom 36 in a length direction L of the boom 36.

With reference to FIGS. 3-5, the crane 10 also includes a boom actuator system 54 configured to perform one or more actuator operations to selectively interact with the telescoping sections 52. In one example, the boom actuator system 54 is configured to perform a sequence of actuator operations to move a telescoping section 52 in the length direction L to adjust a length of the telescoping boom 36. In one example, the boom actuator system 54 includes a telescoping member 56 and a locking head 58 arranged on, and movable with, the telescoping member 56. The telescoping member 56 may include a base part 60 and a slide part 62 configured for telescoping movement relative to the base part 60 in the length direction L.

The locking head 58 is mounted on the slide part 62. The locking head 58 includes one or more pinning members configured to selectively interact with the telescoping sections 52. The pinning members may include, for example, one or more cylinder pins 64 and/or one or more section lock arms 66.

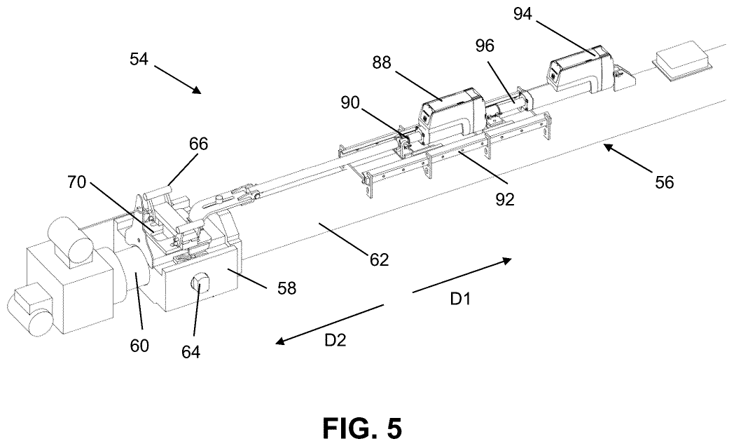

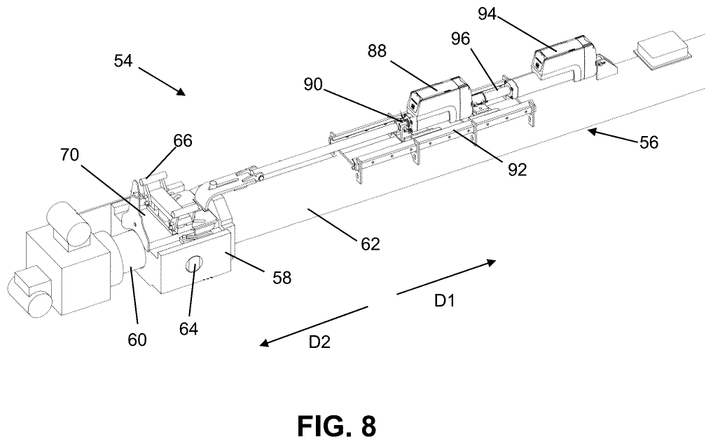

FIG. 4B shows a portion of the telescoping boom 36 with the boom actuator system 54 removed for clarity. In one example, the cylinder pins 64 are movable from an extended position (FIG. 5) to retracted position (FIG. 8) and from the retracted position to the extended position. In the extended position, the cylinder pins 64 are configured to engage corresponding pin holes 68 (FIG. 4B) of a selected telescoping section 52 (e.g., the T5 section) to couple the selected telescoping section 52 to the boom actuator system 54. In the retracted position, the cylinder pins 64 are withdrawn from the pin holes 68 to uncouple the selected telescoping section 52 from the boom actuator system 54.

The section lock arms 66 are movable from a locking position to an unlocking position for unlocking a section lock 67 of the selected telescoping section 52 (e.g., the T5 section), and from the unlocking position to the locking position for locking the section lock 67 of the selected telescoping section 52 (e.g., the T5 section). With the section lock 67 locked, movement of the selected telescoping section 52 (e.g., the T5 section) relative to an adjacent telescoping section 52 (e.g., the T4 section) in the length direction L is substantially prevented or limited. With the section lock 67 unlocked, movement of the selected telescoping section 52 (e.g., the T5 section) relative to the adjacent telescoping section 52 (e.g., the T4 section) in the length direction L is allowed. With further reference to the views depicted in FIGS. 3, 4A and 4B, the section lock 67 (FIGS. 4A and 4B), when locked, is configured to engage a corresponding section lock hole 69 (FIG. 3) disposed along a length of the outwardly adjacent telescoping section 52 (e.g., the T4 section). The section lock holes 69 are disposed at locations corresponding to different extension positions (e.g., 0%, 25%, 50%, 75%, 100%) at which the telescoping section being moved (e.g., the T5 section) may be positioned. Conversely, the section lock 67, when unlocked, is disengaged from the section lock holes 69.

Accordingly, in the examples herein, the actuator operations of the boom actuator system 54 may include, for example, one or more PINNING OPERATIONS relating to interactions between the pinning members 64, 66 and the telescoping sections 52 and one or more TELESCOPE OPERATIONS relating to interactions between the telescoping member 56 and the telescoping sections 52. For example, a PINNING OPERATION may include one or more actuator operations to move the cylinder pins 64 from the extended position to the retracted position and/or from the retracted position to the extended position. A PINNING OPERATION may also, or alternatively, include one or more actuator operations to move the section lock arms 66 from the locking position to the unlocking position and/or from the unlocking position to the locking position.

A TELESCOPE OPERATION may include one or more actuator operations to extend the telescoping member 56 in the length direction L (i.e., first and/or second directions D1, D2) and/or one or more actuator operations to retract the telescoping member 56 in the length direction L. Various PINNING OPERATIONS and TELESCOPE OPERATIONS may be performed in a predetermined sequence such that the boom actuator system 54 is configured to extend a telescoping section 52 to increase the boom length and/or the retract a telescoping section 52 to decrease the boom length.

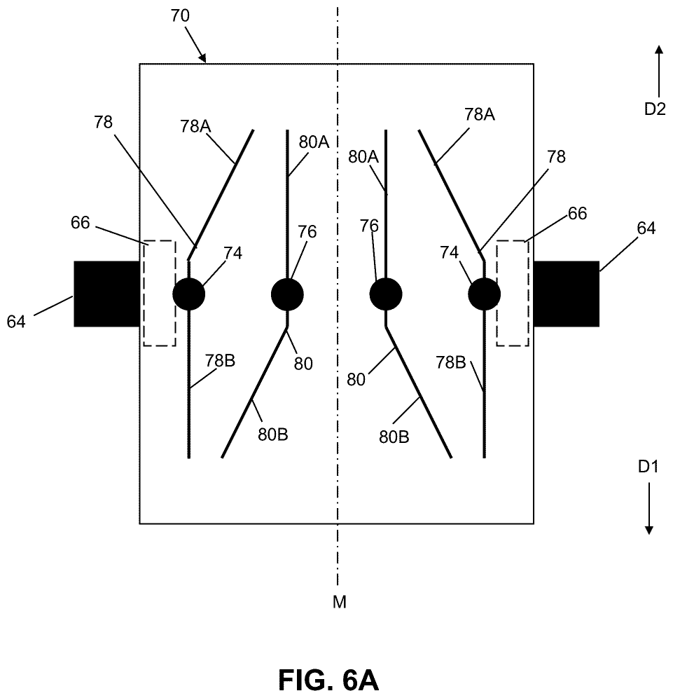

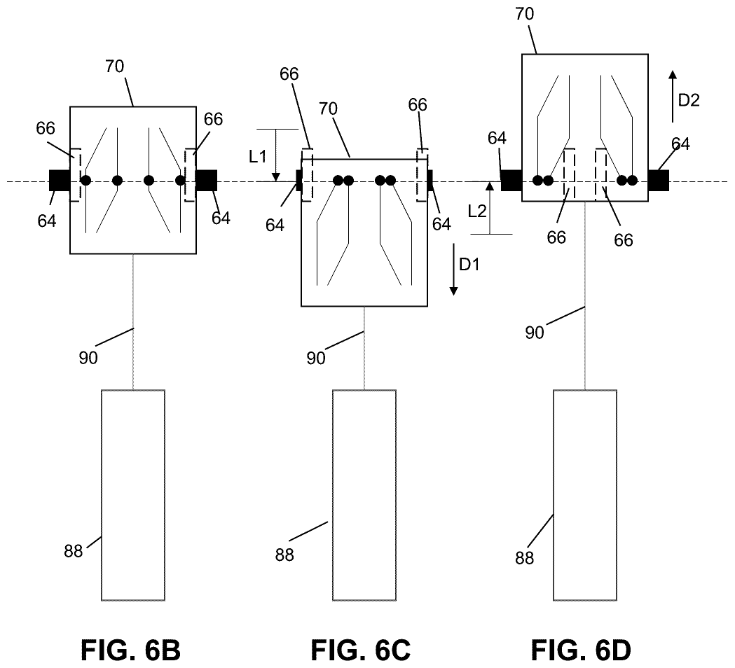

As shown in FIGS. 5 and 6A-6D, the boom actuator system 54 may also include an operating plate 70 provided on the locking head 58. The operating plate 70 is configured for movement relative to the locking head 58 along a movement axis M to interact with one or more of the pinning members 64, 66 and cause movement of one or more of the pinning members 64, 66.

The operating plate 70 is coupled to the pinning members 64, 66 with one or more corresponding pinning member linkages 74, 76. For example, the operating plate 70 may be coupled to the one or more cylinder pins 64 with one or more corresponding pin linkages 74. In addition, the operating plate 70 may be coupled to the one or more section lock arms 66 with one or more corresponding lock linkages 76. In one example, the operating plate 70 includes one or more linkage guides 78, 80 configured to interact with corresponding pinning member linkages 74, 76. The linkage guides 78, 80 may include one or more first guides 78 configured to interact with corresponding pin linkages 74 and one or more second guides 80 configured to interact with corresponding lock linkages 76.

The operating plate 70 is configured for alternating movement relative to the locking head 58 in a first direction D1 and a second direction D2 along the movement axis M. In one example, the operating plate 70 is configured for a first movement in the first direction D1 over a first length L1, a second movement in the second direction D2 over the first length L1, a third movement in the second direction D2 over a second length L2 and a fourth movement in the first direction D1 over the second length L2. Each of the first, second, third and fourth movements may be configured to cause movement of a pinning member 64, 66. For example, the first movement may cause the cylinder pins 64 to move from the extended position to the retracted position and the second movement may cause the cylinder pins 64 to move from the retracted position to the extended position. Additionally, or alternatively, the third movement may cause the section lock arms 66 to move from the locking position to the unlocking position and the fourth movement may cause the section lock arms 66 to move from the unlocking position to the locking position.

In the illustrated examples, the first guides 78 have a first segment 78A arranged at a non-parallel angle relative to the movement axis M configured to interact with the pin linkages 74 during the operating plate first and second movements to cause movement of the cylinder pins 64. The first guides 78 have a second segment 78B arranged parallel to the movement axis M configured to interact with the pin linkages 74 during operating plate third and fourth movements to maintain the cylinder pins 64 in the extended position.

The second guides 80 have a first segment 80A arranged at a parallel angle relative to the movement axis M configured to interact with the lock linkages 76 during the operating plate first and second movements to maintain the section lock arms 66 in the locking position. The second guides 80 have a second segment 80B arranged at a non-parallel angle to the movement axis M configured to interact with the lock linkages 76 during the operating plate third and fourth movements to cause movement of the section lock arms 66.

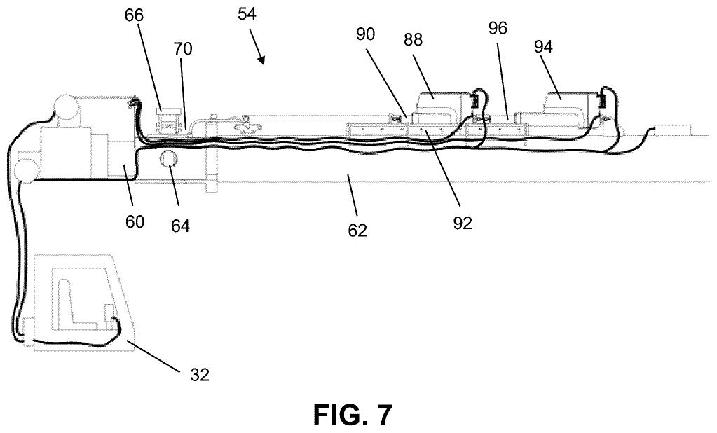

With additional reference to FIG. 7, the boom actuator system 54 may further include a first electric actuator 88 mounted on the telescoping member 56. The first electric actuator 88 has a first drive arm 90 movable in response to operation of the first electric actuator 88. The first electric actuator 88 is operably connected to the operating plate 70 such that movement of the first drive arm 90 causes movement of the operating plate 70 along the movement axis M. For example, first electric actuator 88 may be operated to move the first drive arm 90 in such a way to cause the first, second, third and fourth movements of the operating plate 70, and in turn, cause movements of the pinning members 64, 66.

In one example, the first electric actuator 88 is mounted on the slide part 62 to be held against movement relative to the slide part 62. Alternatively, the first electric actuator 88 may be mounted on a track 92 on the slide part 62. The first electric actuator 88 may be selectively held against movement relative to the track 92 and the slide part 62 and, alternately, allowed to move along the track 92 relative to the slide part 62.

The boom actuator system 54 may optionally include a second electric actuator 94 mounted on the slide part 62. The second electric actuator 94 includes a second drive arm 96 configured for movement in response to operation of the second electric actuator 94. The second drive arm 96 is connected to the first electric actuator 88 and may hold the first electric actuator 88 in position relative to the slide part 62.

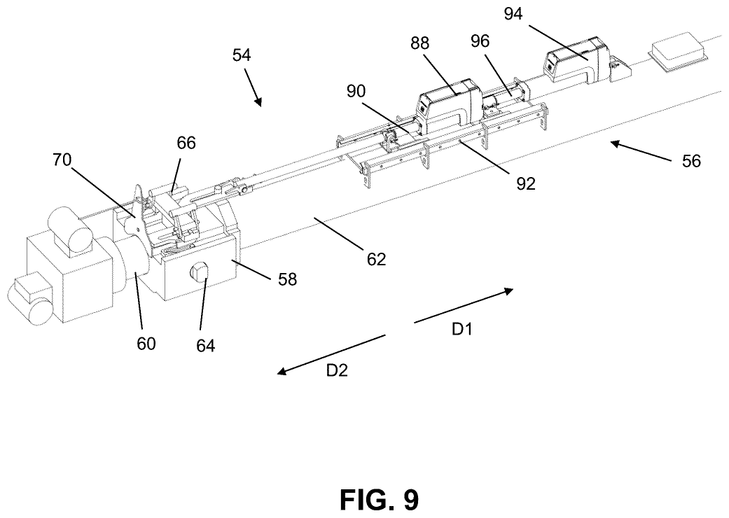

Referring now to FIGS. 5, 6, 8 and 9, in various examples, the boom actuator system 54 is configured to perform actuator operations including, for example, one or more of the PINNING OPERATIONS relating to interactions between the pinning members 64, 66 and the telescoping sections 52 and the TELESCOPE OPERATIONS relating to interactions between the telescoping member 56 and the telescoping sections 52. For example, a PINNING OPERATION may include one or more actuator operations to move the cylinder pins 64 from the extended position to the retracted position and/or from the retracted position to the extended position. In the extended position, the cylinder pins 64 may be received in pin holes 68 of a telescoping section 52 to couple the telescoping member 56 to the telescoping section 52. A PINNING OPERATION may also, or alternatively, include one or more actuator operations to move the section lock arms 66 from the locking position to the unlocking position and/or from the unlocking position to the locking position. In the locking position, the telescoping section 52 (e.g., the T5 section) is locked to an adjacent telescoping section 52 (e.g., the T4 section) and is held against telescoping movement relative to the adjacent section 52.

In the illustrated examples, the PINNING OPERATION(S) may include one or more of a PIN RETRACT operation, a PIN EXTEND operation, a SECTION ARM UNLOCK operation and a SECTION ARM LOCK operation. The boom actuator system 54 may perform the PIN RETRACT operation to move the cylinder pins 64 from the extended position to the retracted position while maintaining the section lock arms 66 in the locking position. For example, the first electric actuator 88 may perform an operation to move the first drive arm 90 to cause the first movement of the operating plate 70.

The boom actuator system 54 may perform the PIN EXTEND operation to move the cylinder pins 64 from the retracted position to the extended position while maintaining the section lock arms 66 in the locking position. For example, the first electric actuator 88 may perform an operation to move the first drive arm 90 to cause the second movement of the operating plate 70.

The boom actuator system 54 may also perform the SECTION ARM UNLOCK operation to move the section lock arms 66 from the locking position to the unlocking position while maintaining the cylinder pins 64 in the extended position. For example, the first electric actuator 88 may perform an operation to move the first drive arm 90 to cause the third movement of the operating plate 70.

The boom actuator system 54 may also perform the SECTION ARM LOCK operation to move the section lock arms 66 from the unlocking position to the locking position while maintaining the cylinder pins 64 in the extended position. For example, the first electric actuator 88 may perform an operation to move the first drive arm 90 to cause the fourth movement of the operating plate 70.

A TELESCOPE OPERATION may include one or more actuator operations to extend the telescoping member 56 in the length direction L and/or one or more actuator operations to retract the telescoping member 56 in the length direction L. In the illustrated examples, the TELESCOPE OPERATION(S) may include one or more of a TELESCOPE EXTEND operation, a TELESCOPE RETRACT operation, a TELESCOPE REPOSITION operation and a TELESCOPE ADJUST operation. The boom actuator system 54 may perform the TELESCOPE EXTEND operation to extend the telescoping member 56 in the length direction L to extend a telescoping section 52 coupled to the telescoping member 56 via cylinder pins 64. The boom actuator system 54 may perform the TELESCOPE RETRACT operation to retract the telescoping member 56 in the length direction L to retract a telescoping section 52 coupled to the telescoping member 56 via cylinder pins 64.

In addition, the boom actuator system 54 may perform the TELESCOPE REPOSITION operation to extend or retract the telescoping member 56 to reposition the locking head 58 adjacent to pin holes 68 of a telescoping section 52 to be extended or retracted. The boom actuator system 54 may perform the TELESCOPE ADJUST operation to alternately extend and retract the telescoping member 56 over a predetermined adjustment length and through predetermined number of cycles. The predetermined adjustment length is a relatively short distance, for example, compared to a length moved by the telescoping member 56 in the TELESCOPE EXTEND operation and the TELESCOPE RETRACT operation to extend and retract a telescoping section 52 to a different extension position. That is, the TELESCOPE ADJUST operation may involve movement of the telescoping member 56 over a relatively short distance to facilitate a pinning operation, such as the PIN RETRACT, PIN EXTEND, SECTION ARM UNLOCK and/or SECTION ARM LOCK operation at a particular cylinder pin hole 68 or a particular section lock 67 or section lock hole 69, while the TELESCOPE EXTEND and TELESCOPE RETRACT operations may involve movement of the telescoping member 56 in the length direction L to adjust an extension length/position of a telescoping section 52 coupled to the telescoping member 56.

Various PINNING OPERATIONS and TELESCOPE OPERATIONS may be performed in a predetermined sequence such that the boom actuator system 54 is configured to extend a telescoping section 52 to increase the boom length and/or the retract a telescoping section 52 to decrease the boom length.

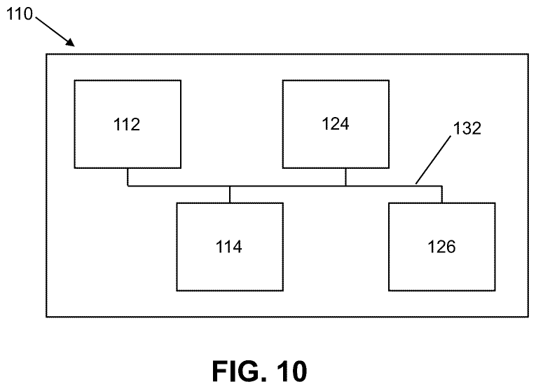

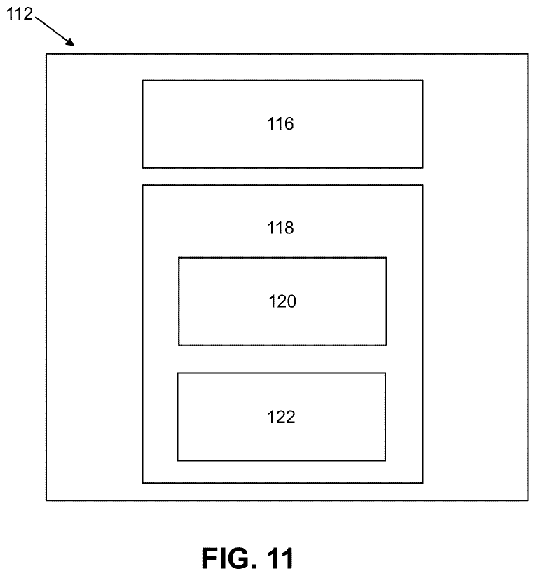

With reference to FIGS. 10 and 11, the crane 10 further includes a control system 110 operably connected to the boom actuator system 54 or incorporated as part of the boom actuator system 54. The control system 110 is configured to control one or more operations of the boom actuator system 54. For example, the control system 110 may be configured to control the boom actuator system 54 to perform actuator operations to extend a length of the telescoping boom 36 and/or retract a length of the telescoping boom 36.

The control system 110 may include or be implemented as a computing device having one or more memory devices 112 and a processing unit 114 operably connected to the memory device(s) 112. The one or more memory devices 112 may include any suitable data storage mechanism, such as a random-access memory (RAM), read-only memory (ROM), disk drive, solid state memory drive, optical disc drive and the like, including various combinations of such data storage mechanisms or systems. The one or more memory devices 112 may also include, for example, a non-transitory computer-readable medium configured to store and allow access to information such as the program instructions 116, code and/or other data. The memory device(s) 112 may also store parameter information 118 and/or other information or data that may be used (i.e., is readable and/or writeable) by the processing unit 114.

Parameter information 118 may include, for example, operating parameter information 120 and/or target parameter information 122. Parameter information 118 includes information relating to one or more parameters of the crane 10 including parameters relating to a crane system (e.g., the boom actuator system 54) and/or a crane component. Operating parameter information 120 may relate to parameters that may vary during a crane operation, and may be indicative of, for example, parameter values and/or qualitative conditions. Target parameter information 122 may relate to various limits, ranges, selected values, preferred or desired qualitative conditions, and the like for various parameters that may vary during a crane operation. For example, operating parameter information may relate to a parameter value detected during a crane operation and target parameter information may relate to a range of values within which the detected parameter value should fall for a particular crane operation.

The program instructions 116, when executed by the processing unit 114, may cause the processing unit 114 to perform one or more functions (i.e., methods, processes, procedures, and/or operations described herein). In some examples, the information stored by the memory device(s) 112 may be used by the processing unit 114, for example, when executing the program instructions 116 and/or in response to executing the program instructions 116.

The processing unit 114 may be implemented as one or more of a central processing unit (CPU), a microprocessor, a microcontroller, an application-specific integrated circuit (ASIC), and the like, including various combinations of the same. It will be appreciated that other types of known, suitable circuitry configured to execute one or more program instructions, and in response to executing the program instructions, perform one or more functions according to the program instructions may be implemented as well. The processing unit 114 is operably connected to the memory device(s) 112 such that the processing unit 114 may access (or read) information from the memory device(s) 112 and/or save (or write) information to the memory device(s) 112.

Referring again to FIG. 10, the control system 110 may also include a communication device 124 configured to transmit information to and/or receive information from other electronic devices. Thus, the communication device 124 may include one or more of a transceiver or transceiver like device for transmitting information and a receiver or receiver like device for receiving information. For example, the communication device 124 may include one or more known, suitable, wired or wireless communication interfaces, or both. A wired communication interface may include connectors configured to interface with data cables and/or data and power cables, such as coaxial, fiberoptic, single conductor, twisted pair cables and/or other known, suitable connectors for use with known, suitable wired data and/or data and power cables. Wireless communication interfaces may include interfaces configured to facilitate, for example, radio and/or microwave communications, including Wi-Fi communications, cellular communications, low power wide area network communications, satellite communications, wireless sensor communications, short-range wireless communications and/or other suitable wireless communication technologies or combinations of suitable wireless communications.

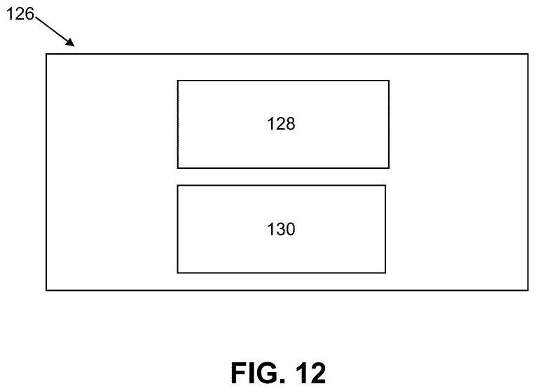

With reference to FIGS. 10 and 12, the control system 110 may also include a user interface 126, including one or more user input devices 128 and/or one or more user output devices 130. User input devices 128 are configured to receive an input or instruction from a user and provide an input signal to the processing unit 114, which may cause the processing unit 114 to execute program instructions 116 to perform a function corresponding to the input signal. Examples of user input devices 128 include one or more of a touch screen display, pushbutton, switch, dial, lever, keyboard, keypad, number pad, microphone, one or more sensors (e.g., motion sensor, biometric sensor, and the like), joystick, pointing device (e.g., mouse), scanner (e.g., optical, barcode, QR, RFID, etc.), pedal and/or various combinations of the same, including other known, suitable user input devices. The user output device 130 is configured to provide information to the user, for example, in the form of text, numerical or graphical information, audio information, visual information and/or haptic or other sensory information. Examples of user output devices 130 may include one or more of a display screen, speaker, light(s), vibratory/haptic motor and/or various combinations of the same, including other known, suitable user output devices. In some examples, a user input device 128 and a user output device 130 may be integrated as a single device, such as a touch screen display configured to receive user input and output information to the user.

The various components of the control system 110 may be arranged on and connected to one another along a communication bus 132. In this manner, information may be transferred between the components of the control system 110.

In the present examples, the control system 110 may be an independent system or a sub-system of another control system, such as a crane control system or the boom actuator system 54. Further, the functions performed by the control system 110 described herein may be performed by one or more sub-systems of the control system 110 or by other systems connected to the control system 110. Moreover, the components of the control system 110 may be shared with other, connected control systems and/or a centralized control system. In some examples, the components of the control system 110 may be implemented in various control devices, such as a wireless control device configured to provide user input to an on-board control system. Individual control devices of the control system 110 may include one or more memory devices 112, processing units 114, and other control system components (communication device(s), user interface(s), and the like) separate from the other control system devices. For example, the control system 110 may include multiple computer devices, each computer device having at least one processing unit and at least one memory device.

Moreover, the control system 110 may be provided as an on-board system, a remote system, or a hybrid system in which various components of the control system 110 may be provided as a combination of on-board and remote components (relative to the crane 10) configured to interact and/or communicate with one another.

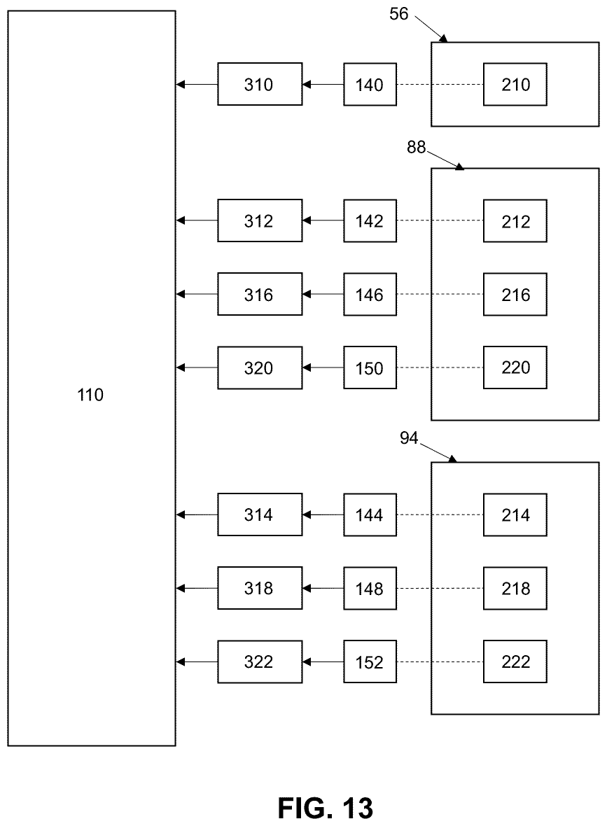

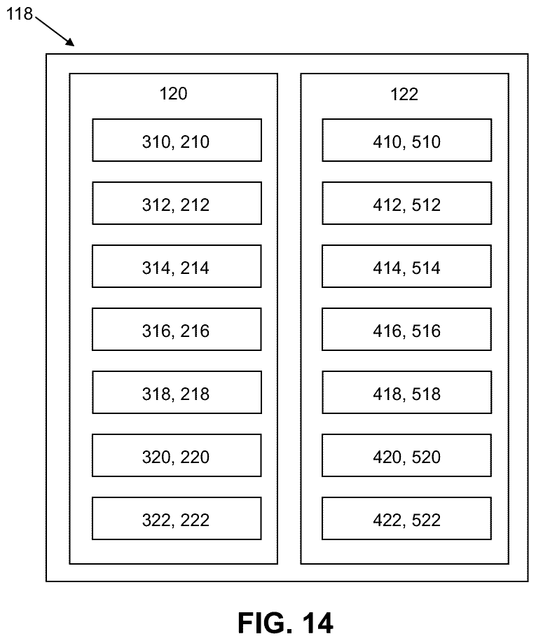

With reference to FIGS. 13 and 14, in the present examples, the parameter information 118 includes parameter information relating to parameters of the boom actuator system 54, such as the telescoping member 56, the first electric actuator 88 and the optional second electric actuator 94. Various parameters may include a telescope extension length 210 of the telescoping member 56, a first extension length 212 of the first electric actuator 88 (e.g., an extension length of the first drive arm 90), a second extension length 214 of the optional second electric actuator 94 (e.g., an extension length of the second drive arm 96), a first electric current draw 216 of the first electric actuator 88, a second electric current draw 218 of the optional second electric actuator 94, a first speed 220 of the first electric actuator 88 and a second speed 222 of the second electric actuator 94. Values for the various parameters may be determined, for example, in part based on sensor measurements associated with the parameters and/or information input by a user and/or stored in the one or more memory device(s) 112.

Accordingly, in the present examples, the parameter information 118 includes operating parameter information 120 such as telescope length information 310 relating to the telescope extension length 210 of the telescoping member 56, first length information 312 relating to the first extension length 212 of the first electric actuator 88, and second length information 314 relating to the second extension length 214 of the optional second electric actuator 94. The operating parameter information 120 may also include first draw information 316 relating to the electric current draw 216 of the first electric actuator 88 during an actuator operation, second draw information 318 relating to the electric current draw 218 of the optional second electric actuator 94 during an actuator operation, first speed information 320 relating to the speed 220 of the first electric actuator 88 during an actuator operation and second speed information 322 relating to the speed 222 of the optional second electric actuator 94 during an actuator operation.

Further, the target parameter information 122 includes predetermined, baseline, predicted, expected, selected, input, configured and/or threshold parameter information relating to parameters of various crane components. For example, target parameter information 122 may include target telescope length information 410 relating to one or more known telescope extension lengths 510 of the telescoping member 56 for different actuator operations. For example, the target telescope length information 410 may include known telescope extension lengths 510 corresponding to the position of the pin holes 68 of each telescoping section T1-T5 at different extension positions (e.g., 0%, 50%, 100%) of each telescoping section 52.

The target parameter information 122 may also include target first length information 412 relating to known first extension lengths 512 of the first electric actuator 88 (i.e., extension lengths of the first drive arm 90) for different actuator operations. For example, the target first length information 412 may include known first extension lengths 512 of the first electric actuator 88 corresponding to different positions of the pinning members 64, 66. In the illustrated examples, the known first extension lengths 512 correspond to the extended position of the cylinder pins 64, the retracted position of the cylinder pins 64, the locking position of the section lock arms 66 and/or the unlocking position of the section lock arms 66.

The target parameter information 122 may also include target second length information 414 relating to known second extension lengths 514 of the optional second electric actuator 94 (i.e., extension lengths of the second drive arm 96) for different actuator operations. For example, the target second length information 414 may include known second extension lengths 514 corresponding to different positions of the pinning members 64, 66.

The target parameter information 122 may also include target first draw information 416 and optionally target second draw information 418 relating to first and second electric current draw limits 516, 518 for the first electric actuator 88 and the optional second electric actuator 94 for different actuator operations. Accordingly, the electric current draw limits 516, 518 may vary depending on the actuator operation.

The target parameter information 122 may also include target first speed information 420 and optionally target second speed information 422 relating to a first configuration speed 520 for the first electric actuator 88 and a second configuration speed 522 for the optional second electric actuator 94. The configuration speeds 520, 522 may be predetermined or known speeds at which the actuators 88, 94 are to be operated for different actuator operations. The configuration speeds 520, 522 may be, for example, one or more of a speed limit, speed range, and/or a predetermined or set speed 520, 522 for the electric actuators 88, 94 for different actuator operations. Accordingly, the configuration speeds 520, 522 of the first electric actuator 88 and the optional second electric actuator 94 may vary depending on the selected actuator operation.

The configuration speed 520 of the first electric actuator 88 may be, for example, a specific speed value or a percentage of a top speed for the first electric actuator 88. For example, the configuration speed 520 may be 25%, 50%, 75% or 100% of the top speed for the first electric actuator 88 depending on the selected actuator operation. It will be appreciated that the speeds listed above are presented as examples only, and the present disclosure is not limited to these examples. Similar configuration speeds 522 may be provided for the second electric actuator 94.

The first electric current draw 216 may vary depending on the first speed 220 of the first electric actuator 88. In general, the first electric current draw 216 increases with the first speed 220. For example, the first electric current draw 216 of the first electric actuator 88 operating at a speed of 75% is typically greater than the first electric current draw 216 of the first electric actuator 88 when operated at a speed of 50%.

The first electric current draw limit 516 may vary depending on the actuator operation as well. For example, the first electric current draw limit 516 may be higher for relatively higher configuration speeds 520, and lower for relatively lower configuration speeds 520. In one example, the first electric current draw limit 516 may be higher for a first configuration speed of 75% than for a first configuration speed of 50%. The electric current draw 218 and the electric current draw limit 518 of the optional second electric actuator 94 may vary depending on the second speed 222 and second configuration speed 522 of the second electric actuator 94 in a similar manner.

According to various examples, the control system 110 may store the target first draw information 416 including the first electric current draw limit 516 of the first electric actuator 88. The control system 110 may determine the first electric current draw limit 516 for a selected actuator operation based on the first configuration speed 520 for the selected actuator operation. Alternatively, or in addition, the first electric current draw limit 516 may be provided to the control system 110 as a predetermined draw limit 516 for different actuator operations.

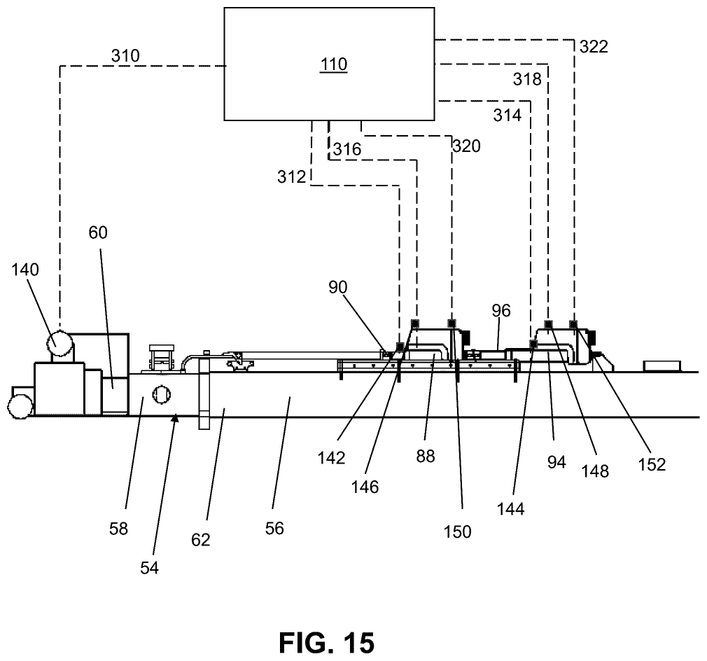

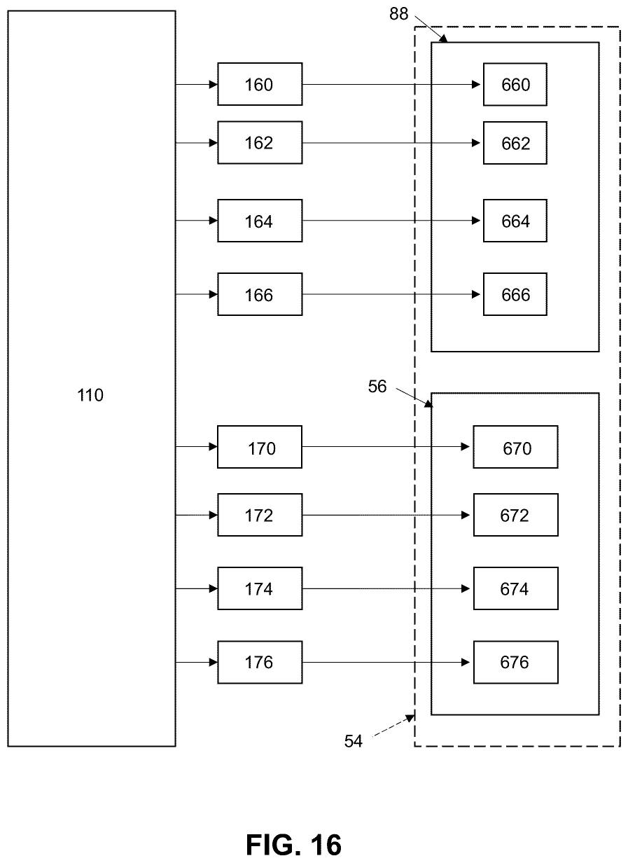

Referring to FIGS. 13 and 15, the control system 110 is configured to receive parameter information 118 in any suitable manner. For example, the control system 110 may receive at least some operating parameter information 120 from one or more sensors. For instance, a telescoping member length sensor 140 may detect the telescope extension length 210 of the telescoping member 56 and transmit the telescope length information 310 to the control system 110. The crane 10 may also include a first arm length sensor 142 configured to detect the first extension length 212 of the first electric actuator 88 and transmit first length information 312 to the control system 110, and optionally a second arm length sensor 144 configured to detect the second extension length 214 of the second electric actuator 94 and transmit second length information 314 to the control system 110.

In some examples, the crane 10 may include a first electric current sensor 146 configured to detect the first electric current draw 216 of the first electric actuator 88 and transmit first draw information 316 to the control system 110. The crane 10 may also include a second electric current sensor 148 configured to detect the second electric current draw 218 of the second electric actuator 94 and transmit second draw information 318 to the control system 110.

Additionally, the crane 10 may include a first speed sensor 150 configured to detect the first speed 220 of the first electric actuator 88 and transmit first speed information 320 to the control system 110. The crane 10 may also include a second speed sensor 152 configured to detect the second speed 222 of the second electric actuator 96 and transmit second speed information 322 to the control system 110.

Alternatively, or in addition, the control system 110 may be configured to derive at least some parameter information using other parameter information. For example, the control system 110 may be configured to determine first speed information 320 and second speed information 322 using the first length information 312 and the second length information 314, respectively, and a known time interval over which a change in first and/or second length information 320, 322 has occurred.

The target parameter information 122 may be stored by the control system 110 by being provided to the control 110 and/or derived by the control system 110. For example, the target parameter information 122 may be provided to the control system 110 from user input via the input device 128, from a crane component having stored target parameter information 122, and/or by storing parameter values obtained from a testing, setup or calibration procedure, or the like, including various combinations. Parameter values may be obtained from a testing, setup, calibration or similar procedures, for example, by measuring the parameter values or using information received from one or more sensors configured to detect the parameter values and transmit corresponding parameter information to the control system 110. Alternatively, or in addition, the control system 110 may derive target parameter information 122 using other parameter information received at the control system 110. In this manner, the control system 110 may determine (calculate, predict, and/or estimate) target parameter information 122 for various parameters.

Thus, in various examples, the control system 110 may store the target telescope length information 410 including known telescope extension lengths 510 corresponding to positions where pinning members 64, 66 are expected to align with corresponding pinning parts (e.g., pin holes 68, section locks 67) of the telescoping sections 52 at different extension positions of the telescoping sections 52. The known telescope extension lengths 510 may be provided for example, by recording the telescope extension lengths 210 at which the pinning members 64, 66 align with corresponding section parts in a set up procedure or by providing the known telescope extension lengths 510 as previously determined in a similar crane configuration (i.e., as determined in a similarly configured crane).

The control system 110 may store the target first and second length information 412, 414 including known first and second extension lengths 512, 514 corresponding to different positions of the pinning members 64, 66. The known first and/or second extension lengths 512, 514 may be provided, for example, by recording the first and second extension lengths 212, 214 at which the pinning members 64, 66 are in known or selected positions in a set up procedure or by providing the known first and/or second extension lengths 214, 216 as previously determined in a similar crane configuration.

The control system 110 may store the target first and/or second draw information 416, 418 including first and second electric current draw limits 516, 518 corresponding to different first and/or second configuration speeds 520, 522 of the actuators 88, 94. The first and/or second electric current draw limits 516, 518 may be provided based on known first and/or second electric current draws 216, 218 of the actuators 88, 94 at different actuator speeds, and optionally include a tolerance added to the known electric current draws. The known first and/or second electric current draws 216, 218 may be provided as a factory setting on the actuators 88, 94, and/or determined by measuring the electric current draw of each actuator 88, 94 operating at different speeds in a set up procedure. Alternatively, or in addition, the first and/or second electric current draw limits 516, 518 provided to the control system 110 after being previously determined in a similar crane configuration.

The control system 110 may store the target first and/or second speed information 420, 422 including the first and/or second configuration speeds 520, 522 corresponding to speeds at which the actuators 88, 94 are to be operated for different actuator operations. The configuration speeds 520, 522 may be provided, for example, by recording first and/or second speeds 220, 222 in a set up procedure which provide desired operating characteristics, or by providing known first and/or second configuration speeds 520, 522 as previously determined in a similar crane configuration.

In some examples, the target parameter information 122 is dynamic and may change during performance of an actuator operation, for example, depending on parameter information 118 received at the control system 110. Alternatively, or in addition, different target parameter information 122 may vary depending on the actuator operation to be performed. That is, different target information 122 may be used for different actuator operations.

The control system 110 is configured to provide one or more control signals corresponding to different actuator operations to the boom actuator system 54. The control signals may be provided using the parameter information 118 as described further in the present examples. In general, the control system 110 is configured to provide a control signal to the boom actuator system 54 to perform an actuator operation. For example, the control system 110 may provide a PINNING OPERATION control signal to the first electric actuator 88 to perform one or more PINNING OPERATIONS. The control system 110 may also provide a TELESCOPE OPERATION control signal to the telescoping member 56 to perform one or more TELESCOPE OPERATIONS.

In various embodiments, the control signal may include parameter information 118 related to the corresponding actuator operation to be performed. For example, a control signal may include target information 122 for the telescoping member 56 and/or the first electric actuator 88 for the actuator operation to be performed. For example, the control system 110 may provide a control signal including target telescoping member information 410 to the telescoping member 56 for a TELESCOPE OPERATION. Alternatively, or in addition, the control system 110 may provide a control signal including one or more of the target first length information 412, the target first draw information 416, and/or the target first speed information 420 to the first electric actuator 88 for a PINNING OPERATION.

The boom actuator system 54 is configured to initiate an actuator operation in response to receiving the control signal. The boom actuator system 54, or a component of the boom actuator system 54 (e.g., the telescoping member 56 and the first electric actuator 88) may then operate according to parameter information received in the control signal. For example, the first electric actuator 88 may operate at a first speed 220 according to the first configuration speed 520 in the target first speed information 420 provided in the control signal for the selected actuator operation, to cause movement of the first drive arm 90 to a first extension length 212 corresponding to a known first extension length 512 in the target first length information 412 also provided in the control signal for the selected actuator operation. The first electric actuator 88 draws a first electric current 216 based on the first speed 220, and the control system 110 stores a target first electric current draw limit 516 based on the first configuration speed 520 for the selected actuator operation.

The boom actuator system 54 is configured to perform the actuator operation until a parameter condition is met. In various examples, the control system 110 may be configured to stop the actuator operation when a parameter condition is met by controlling the boom actuator system 54 to stop performing the operation (e.g., to stop operation of the telescoping member 56 and/or the first electric actuator 88). Alternatively, or in addition, the boom actuator system 54 may stop performance of an operation in response to a parameter condition being met. In various examples, the boom actuator system 54 may provide information to the control system 110 indicating that an actuator operation has been stopped and/or the control system 110 may determine that an actuator operation has been stopped based on the parameter information 118.

Parameter conditions may include, for example, passing of a predetermined time period for the actuator operation and/or satisfying a predetermined relationship between operating parameter information 120 and target parameter information 122. In various embodiments, the control system 110 and/or the boom actuator system 54 may be configured to compare operating parameter information 120 to target parameter information 122 during and/or after performance of an actuator operation to determine if the predetermined relationship is satisfied.

The control system 110 is configured to determine whether the telescoping member 56 and/or a pinning member 64, 66 is in the selected position corresponding to the actuator operation in response to performance of the actuator operation using the parameter information 118. For example, the control system 110 may determine whether a pinning member 64, 66 is in the selected position corresponding to the actuator operation based on the relationship between the first length information 312 and the target first length information 412 for the actuator operation performed, and/or the relationship between the first draw information 316 and target first draw information 416 for the actuator operation.

According to an illustrated example, the control system 110 may determine that a pinning member 64, 66 is in the selected position for the actuator operation performed if the first length information 312 is equal to the target first length information 412 for the actuator operation and the first draw information 316 does not exceed the target first draw information 416. An indication that the first length information 312 is equal to the target first length information 412 is an indication that the first drive arm 90 has completed an intended movement, and further, that the operating plate 70 has completed a movement causing the pinning member 64, 66 to move to the selected position. An indication that the first draw information 316 does not exceed the target first draw information 416 indicates that the first electric actuator 88 does not require additional power to move the first drive arm 90, which in turn, indicates that the first drive arm 90 did not encounter resistance indicative of the operating plate 70 being held against movement due to a pinning member 64, 66 being stuck.

It will be appreciated that in various examples, the parameter information 118 may include parameter values and/or qualitative information regarding a particular parameter. Thus, in the example above, the first length information 312 may include the extension length value 212 of the first electric actuator 88 and the target first length information 412 may include a target extension length value 512 for the actuator operation, and the extension length information 312 may be compared to the target extension length information 412 to determine whether the first length value 212 is equal to the target first length value 512.

Conversely, the control system 110 may determine that a pinning member 64, 66 is not in the selected position for the actuator operation performed if the first length information 312 is not equal to the target first length information 412 for the actuator operation, or if the first draw information 316 exceeds the target first draw information 416 for the actuator operation. In this example, an indication that the first length information 312 is not equal to the target first length information 412 is an indication that the first drive arm 90 did not reach the target (known) first extension length 512 for the actuator operation, and further, that the operating plate 70 did not complete a movement to cause the pinning member 64, 66 to move to the selected position. An indication that the first draw information 316 exceeds the target first draw information 416 is also an indication that the first electric actuator 88 requires additional power to move the first drive arm 90, which may occur when the movement of the operating plate 70 is inhibited due to the pinning member 64, 66 being stuck or otherwise held against movement due to a position of the pinning member 64, 66 relative to a telescoping section 52.

The control system 110 is configured to provide a control signal to the boom actuator system 54 causing the boom actuator system 54 to perform an actuator operation to adjust a position of the pinning members 64, 66 relative to a telescoping section 52 if the control system 110 determines that the pinning member 64, 66 is not in the selected position for the corresponding actuator operation performed. The boom actuator system 54 is configured to adjust the position of the pinning members 64, 66 by operating the telescoping member 56 to perform a series of relatively short back-and-forth (extend and retract) movements to cause movements of the pinning members 64, 66 in the length direction L to free the pinning members 64, 66 for movement to the selected position.

In the manner above, the control system 110 may control actuator operations of the boom actuator system 54 using the parameter information 118. Various examples of the different actuator operations are described below to further illustrate examples of the control system 110 controlling the boom actuator system 54 to extend and retract telescoping sections T1-T5 to adjust a length of the boom 36. It will be appreciated that the following examples are provided for illustrative purposes and do not limit the scope of this disclosure. Rather, the examples illustrate one manner in which various examples above may be implemented to extend and retract telescoping boom sections. It will be further appreciated that according to the examples herein, the telescoping sections T1-T5 may be extended and retracted automatically, without operator input or intervention after initiation of the process. In particular, incorrect or unselected positioning of a pinning member 64, 66, for example, due to becoming stuck, impinged, misaligned and the like, may be corrected automatically without operator input or intervention to free the pinning members 64, 66 for movement to the selected position. Moreover, the control system 110 may determine such a condition (i.e., wherein the pinning members are not moved/cannot be moved as selected) and performance of the actuator operation may be stopped to adjust a position of the pinning members 64, 66 relative to a telescoping member 52 to free the pinning members 64, 66 for movement in the selected manner.

According to various embodiments, the control system 110 may be configured to provide one or more control signals to control the boom actuator system 54 to perform a series of actuator operations to extend or retract the telescoping boom 36 using the parameter information 118. In the various examples which follow, the control signals may include various parameter information 118, including target parameter information 122, for operating the first electric actuator 88. For example, the control signals for different actuator operations may include target first length information 412 including a known or target first extension length 512 of the first electric actuator 88 which corresponds to the extension length 212 of the first electric actuator 88 at which the pinning member 64, 66 is in the selected position for the selected actuator operation. The control signals may also include target first speed information 420 including a target configuration speed 520 of the first electric actuator 88 corresponding to a speed at which the first electric actuator 88 is to operate for the selected actuator operation. Further, the control signals may optionally include target first draw information 416 including a first electric current draw limit 516 of the first electric actuator 88 for the selected actuator operation.

According to various example operations, the control system 110 may provide the PIN RETRACT control signal 160 to the boom actuator system 54 to perform the PIN RETRACT operation 660, for which the selected position of the pinning member 64, 66 is the retracted position of the cylinder pins 64. The PIN RETRACT control signal 160 may include target first length information 412 including the known first extension length 512 of the first electric actuator 88 at which the cylinder pins 64 are in the retracted position. The PIN RETRACT control signal 160 may also include target first speed information 420 including the first configuration speed 520 at which the first electric actuator 88 is to be operated to perform the PIN RETRACT operation 660.

In response to receiving the PIN RETRACT control signal 160, the first electric actuator 88 is configured to operate at the first configuration speed 520 for the PIN RETRACT operation 660 and draw a first electric current 216 for operating at the first configuration speed 520. The first electric actuator 88 is also configured to move the first drive arm 90 to the known first extension length 512 according to the target first length information 412 for the PIN RETRACT operation 660. Movement of the first drive arm 90 to the known first extension length 512 for the PIN RETRACT operation 660 causes the first movement of the operating plate 70, and in turn, movement of the cylinder pins 64 to the retracted position.

The control system 110 is configured to determine whether the pinning member 64, 66 is in the selected position for actuator operation using the parameter information 118. Thus, for the PIN RETRACT operation 660, the control system 110 is configured to determine whether the cylinder pins 64 are in the retracted position using the parameter information 118. In one example, the control system 110 may determine that the cylinder pins 64 are in the retracted position if the first length information 312 is equal to the target first length information 412 and the first draw information 316 is less than the target first draw information 416 for the PIN RETRACT operation 660. If the control system 110 determines the cylinder pins 64 are in the selected position, then the control system 110 may provide a control signal 170 for the boom actuator system 54 to perform the TELESCOPE REPOSITION operation 670.

If the control system 110 determines the cylinder pins 64 are not in the selected position, i.e., the retracted position, then the control system 110 may provide a TELESCOPE ADJUST control signal 172 to the boom actuator system 54 to perform the TELESCOPE ADJUST operation 672. In response to receiving the TELESCOPE ADJUST control signal 172, the telescoping member 56 is operated to perform one or more relatively short extend and/or retract movements, i.e., adjustment length increments, along the length direction L to adjust a position of the pinning member 64, 66 relative to a telescoping section 52. The first electric actuator 88 may perform further attempts to move the first drive arm 90 to the target (known) first extension length 512 and determine whether the cylinder pins 64 are in the selected position. In some examples, the TELESCOPE ADJUST operation 672 may be performed alternatingly with the PIN RETRACT operation 660 until control system 110 determines the cylinder pins 64 are in the retracted position, or until a TELESCOPE ADJUST operation 672 has been performed a predetermined number of times or for a predetermined period of time. The control system 110 may provide the TELESCOPE REPOSITION control signal 170 to the boom actuator system 54 if the cylinder pins 64 are determined to be in the retracted position.

The control system 110 may provide the TELESCOPE REPOSITION control signal 170 to the boom actuator system 54 to perform the TELESCOPE REPOSITION operation 670. In the TELESCOPE REPOSITION operation 670, the telescoping member 56 is operated to move the locking head 58 to a selected position corresponding to a position of the pin holes 68 of a telescoping section 52 to be moved (i.e., extended or retracted). The TELESCOPE REPOSITION control signal 170 may include various parameter information 118 such as the target telescope length information 410, which includes known telescope extension lengths 510 at which the cylinder pins 64 are intended to be aligned pin holes 68 of a telescoping section 52 to be moved.

In response to receiving the TELESCOPE REPOSITION control signal 170, the telescoping member 56 is configured to move (i.e., extend or retract) the slide part 62 relative to the base part 60 to provide an extension length 210 of the telescoping member 56 corresponding to the known telescope extension 510 for the selected position for the locking head 58 and cylinder pins 64. Thus, the control system 110 is configured to use parameter information 118 such as the telescope length information 310 and the target telescope length information 410 for the TELESCOPE REPOSITION operation 670. In one example, if the control system 110 determines that the telescope length information 310 is equal to the target telescope length information 410, the control system 110 may provide a control signal to the boom actuator system 54 to stop movement of the telescoping member 56 and/or to perform the PIN EXTEND operation 662.

The control system 110 may provide the PIN EXTEND control signal 162 to the boom actuator system 54 to perform the PIN EXTEND operation 662, for which the selected position of the pinning member 64, 66 is the extended position of the cylinder pins 64. The PIN EXTEND control signal 162 may include target first length information 412 including the known first extension length 512 of the first electric actuator 88 at which the cylinder pins 64 are in the extended position. The PIN EXTEND control signal 162 may also include target first speed information 420 including the first configuration speed 520 at which the first electric actuator 88 is to be operated to perform the PIN EXTEND operation 662.

In response to receiving the PIN EXTEND control signal 162, the first electric actuator 88 is configured to operate at the first configuration speed 520 for the PIN EXTEND operation 662 and draw a first electric current 216 for operating at the first configuration speed 520. The first electric actuator 88 is also configured to move the first drive arm 90 to the known first extension length 512 according to the target first length information 412 for the PIN EXTEND operation 662. Movement of the first drive arm 90 to the known first extension length 512 for the PIN EXTEND operation 662 causes the second movement of the operating plate 70, and in turn, movement of the cylinder pins 64 to the extended position.

The control system 110 is configured to determine whether the cylinder pins 64 are in the extended position using the parameter information 118. In one example, the control system 110 may determine that the cylinder pins 64 are in the extended position if the first length information 312 is equal to the target first length information 412 and the first draw information 316 is less than the target first draw information 416 for the PIN EXTEND operation 662. If the control system 110 determines the cylinder pins 64 are in the selected position, then the control system 110 may provide a control signal 164 for the boom actuator system 54 to perform the SECTION ARM UNLOCK operation 664.

If the control system 110 determines the cylinder pins 64 are not in the selected position, i.e., the extended position, then the control system 110 may provide the TELESCOPE ADJUST control signal 172 to boom actuator system 54 to perform the TELESCOPE ADJUST operation 672. In some examples, the TELESCOPE ADJUST operation 672 may be performed alternatingly with the PIN EXTEND operation 662 until control system 110 determines the cylinder pins 64 are in the extended position, or until a TELESCOPE ADJUST operation 672 has been performed a predetermined number of times or for a predetermined period of time. The control system 110 may provide the SECTION ARM UNLOCK control signal 164 to the boom actuator system 54 if the cylinder pins 64 are determined to be in the extended position.

The control system 110 may provide the SECTION ARM UNLOCK control signal 164 to the boom actuator system 54 to perform the SECTION ARM UNLOCK operation 664, for which the selected position of the pinning member 64, 66 is the unlocking position of the section lock arms 66. The SECTION ARM UNLOCK control signal 164 may include target first length information 412 including the known first extension length 512 of the first electric actuator 88 at which the section lock arms 66 are in the unlocking position. The SECTION ARM UNLOCK control signal 164 may also include target first speed information 420 including the first configuration speed 520 at which the first electric actuator 88 is to be operated to perform the SECTION ARM UNLOCK operation 664.

In response to receiving the SECTION ARM UNLOCK control signal 164, the first electric actuator 88 is configured to operate at the first configuration speed 520 for the SECTION ARM UNLOCK operation 664 and draw a first electric current 216 for operating at the first configuration speed 520. The first electric actuator 88 is also configured to move the first drive arm 90 to the known first extension length 512 according to the target first length information 412 for the SECTION ARM UNLOCK operation 664. Movement of the first drive arm 90 to the known first extension length 512 for the SECTION ARM UNLOCK operation 664 causes the third movement of the operating plate 70, and in turn, movement of the section lock arms 66 to the unlocking position.

The control system 110 is configured to determine whether the section lock arms 66 are in the unlocking position using the parameter information 118. In one example, the control system 110 may determine the section lock arms 66 are in the unlocking position if the first length information 312 is equal to the target first length information 412 and the first draw information 316 is less than the target first draw information 416 for the SECTION ARM UNLOCK operation 664. If the control system 110 determines the section lock arms 66 are in the selected position, then the control system 110 may provide a control signal 174, 176 for the boom actuator system 54 to perform the TELESCOPE EXTEND operation 674 or the TELESCOPE RETRACT operation 676.

If the control system 110 determines the section lock arms 66 are not in the selected position, i.e., the unlocking position, then the control system 110 may provide the TELESCOPE ADJUST control signal 172 to the boom actuator system 54 to perform the TELESCOPE ADJUST operation 672. In some examples, the TELESCOPE ADJUST operation 672 may be performed alternatingly with the SECTION ARM UNLOCK operation 164 until control system 110 determines the section lock arms 66 are in the unlocking position, or until a TELESCOPE ADJUST operation 672 has been performed a predetermined number of times or for a predetermined period of time. The control system 110 may provide control signal 174, 176 to the boom actuator system 54 to perform the TELESCOPE EXTEND operation 674 or the TELESCOPE RETRACT operation 676 if the section lock arms 66 are determined to be in the unlocking position.

The control system 110 may provide the TELESCOPE EXTEND control signal 174 to the actuator system 54 to perform the TELESCOPE EXTEND operation 674. In the TELESCOPE EXTEND operation, the telescoping member 56 is operated to extend a telescoping section 52 to a selected position, i.e., an extension position, by moving the slide part 62 relative to the base part 60 to provide an extension length 210 of the telescoping member 56 corresponding to the selected position of the telescoping section 52. The TELESCOPE EXTEND control signal 174 may include various parameter information 118 such as the target telescope length information 410 which includes known telescope extension lengths 510 corresponding various extension positions of the telescoping section 52.

Accordingly, in response to receiving the TELESCOPE EXTEND control signal 174, the telescoping member 56 is operated to extend the slide part 62 relative to the base part 60, and in turn, extend a telescoping section 52 coupled to the telescoping member 56 via cylinder pins 64 engaged in pin holes 68, to a telescope extension length 210 corresponding to the known telescope extension length 510 for a selected extension position of the telescoping section 52 coupled to the telescoping member 56.

In one example, if the control system 110 determines that the telescope length information 310 is equal to the target telescope length information 410 for the TELESCOPE EXTEND operation 674, the control system 110 may provide a control signal 166 for the boom actuator system 54 to stop movement of the telescoping member 56 and/or to perform the SECTION ARM LOCK operation 666.

The control system 110 may provide the TELESCOPE RETRACT control signal 176 to the actuator system 54 to perform the TELESCOPE RETRACT operation 676. In the TELESCOPE RETRACT operation 676, the telescoping member 56 is operated to retract a telescoping section 52 to a selected position, i.e., an extension position, by moving the slide part 62 relative to the base part 60 to provide an extension length 210 of the telescoping member 56 corresponding to the selected position of the telescoping section 52. The TELESCOPE RETRACT control signal 176 may include various parameter information such as the target telescoping length information 410 which includes known telescope extension lengths 510 corresponding to various extension positions of the telescoping section 52.

Accordingly, in response to receiving the TELESCOPE RETRACT control signal 176, the telescoping member 56 is operated to retract the slide part 62 relative to the base part 60, and in turn, retract the telescoping section 52 coupled to the telescoping member 56 via cylinder pins 64 engaged in pin holes 68, to a telescope extension length 210 corresponding to the known telescope extension length 510 for a selected extension position of the telescoping section 52 coupled to the telescoping member 56.

In one example, if the control system 110 determines that the telescope length information 310 is equal to the target telescope length information 410 for the TELESCOPE RETRACT operation 676, the control system 110 may provide a control signal 166 for the boom actuator system 54 to stop movement of the telescoping member 56 and/or to perform the SECTION ARM LOCK operation 666.

The control system 110 may provide the SECTION ARM LOCK control signal 166 to the boom actuator system 54 to perform the SECTION ARM LOCK operation 666, for which the selected position of the pinning member 64, 66 is the locking position of the section lock arms 66. The SECTION ARM LOCK control signal 166 may include target first length information 412 including the known first extension length 512 of the first electric actuator 88 at which the section lock arms 66 are in the locking position. The SECTION ARM LOCK control signal 166 may also include target first speed information 420 including the first configuration speed 520 at which the first electric actuator 88 is to be operated to perform the SECTION ARM LOCK operation 66.

In response to receiving the SECTION ARM LOCK control signal 166, the first electric actuator 88 is configured to operate at the first configuration speed 520 for the SECTION ARM LOCK operation 666 and draw a first electric current 216 for operating at the first configuration speed 520. The first electric actuator 88 is also configured to move the first drive arm 90 to the known first extension length 512 according to the target first length information 412 for the SECTION ARM LOCK operation 666. Movement of the first drive arm 90 to the known first extension length 512 for the SECTION ARM LOCK operation 666 causes the fourth movement of the operating plate 70, and in turn, movement of the section lock arms 66 to the locking position.

The control system 110 is configured to determine whether the section lock arms 66 are in the locking position using the parameter information 118. In one example, the control system 110 may determine the section lock arms 66 are in the locking position if the first length information 312 is equal to the target first length information 412 and the first draw information 316 is less than the target first draw information 416 for the SECTION ARM LOCK operation 666. If the control system 110 determines the section lock arms 66 are in the selected position, then the control system 110 may provide a control signal for the boom actuator system 54 to end operations relating to extending the telescoping boom sections 52 or to perform a subsequent extension/retraction of the telescoping sections 52.

If the control system 110 determines the section lock arms 66 are not in the selected position, i.e., the locking position, then the control system 110 may provide the TELESCOPE ADJUST control signal 172 to the boom actuator system 54 to perform the TELESCOPE ADJUST operation 672. In some examples, the TELESCOPE ADJUST operation 672 may be performed alternatingly with the SECTION ARM LOCK operation 666 until control system 110 determines the section lock arms 66 are in the locking position, or until a TELESCOPE ADJUST operation 672 has been performed a predetermined number of times or a predetermined period of time. The control system 110 may provide a control signal for the boom actuator system 54 to end operations relating to extending the telescoping boom sections 52 or to perform a subsequent extension/retraction of the telescoping sections 52.

In various examples herein, references may be made to relationships between parameters, parameter values, parameter information and the like as being equal, greater than, less than, within range, outside of a range, and/or other similar expressions. It will be appreciated that a parameter, parameter value, and/or parameter information, and the like, is not limited to a single, specific value, but rather, may be provided as a range of values, and that the relationship between parameters, parameter values, parameter information and the like may be considered as being equal if one parameter, parameter value, parameter information and the like falls within such a range of parameters, parameter values, parameter information and the like. As a general example, target parameter information 122 may include a range of values for a target parameter corresponding to a selected actuator operation. The operating parameter information 120 may include a most recent parameter value detected by a sensor during the actuator operation. The control system 110 may determine the operating parameter information 120 to be equal to the target parameter information 122 if the operating parameter information 120 falls within the range of values for the target parameter in the target parameter information 122. Conversely, the control system 110 may determine that the operating parameter information 120 is not equal to the target parameter information 122 if the detected operating parameter value does not fall within range of values for the target parameter.

As an illustrative example, target parameter information 122 relating to the extension length 210 of the telescoping member 56 may be provided as target telescope length information 410 including known telescope extension lengths 510 of the telescoping member 56 for telescoping sections 52 at different extension positions (e.g., at 0%, 25%, 50%, 75% and 100% extension positions). The known telescoping extension lengths 510 may be stored as a range of extension lengths (i.e., an extension length range) for each extension position of the telescoping sections 52, to indicate a range of extension lengths of the telescoping member 56 at which the pinning members 64, 66 are expected to align with corresponding pinning parts 68, 67 of the telescoping sections 52 at a given extension position. Accordingly, the control system 110 may determine that the telescope extension length 210 and/or telescope length information 310 is equal to a known telescope extension length 510 and/or target telescope length information 410 for an extension position of a telescoping section 52 if the telescope extension length 210 and/or telescoping length information 310 falls within the range of telescope extension lengths of the telescoping member 56 according to the known telescope extension lengths 510 and/or the target telescope length information 410.

In use, the telescoping member length sensor 140 may provide the telescope length information 310 including the telescope extension length 210 relating to the most recently detected extension length 210 of the telescoping member 56. The control system 110 is configured to compare the telescope length information 310 to the target telescoping length information 410, for example, by comparing the detected telescoping extension length 210 to the known telescoping extension length range 510 for the extension positions of the telescoping section 52. Extension or retraction of the telescoping member 56 may continue until the control system 110 determines that the telescope length information 310 is equal to, i.e., falls within the range of, the target telescoping length information 410 for the selected actuator operation (e.g., a TELESCOPE REPOSITION operation 670 to reposition the pinning members 64, 66 in alignment with corresponding pinning parts 68, 67 of the T5 section at a 75% extension position).

The control system 110 may then provide a control signal to stop movement of the telescoping member 56 such that the pinning members 64, 66 are expected to be in alignment with the corresponding pinning parts 68, 67 of the telescoping section 52. With further reference to the example above in which the T5 section is at the 75% extension position, the control system 110 may stop the TELESCOPE REPOSITION operation 670 when the telescope length information 310 indicates that the extension length 210 of the telescoping member 56 is within the extension length range 510 at which the cylinder pins 64 are expected to be aligned with pinning holes 68 of the T5 section at the 75% extension position.

Subsequently, the control system 110 may provide, for example, the PIN EXTEND control signal 162 to the first electric actuator 88 to perform the PIN EXTEND operation 662. If, however, the cylinder pins 64 are misaligned with the pin holes 68 of the telescoping section 52, despite the telescope length information 310 being equal to, i.e., within the range of, the target telescope length information 410, movement of the cylinder pins 64 to the selected (extended) position may be inhibited or precluded. Accordingly, the control system 110, after determining the cylinder pins 64 are not in the extended position, may provide the TELESCOPE ADJUST control signal 172 to the telescoping member 56 to adjust the telescope extension length 210 of the telescoping member 56 in relatively small length increments, also referred to as adjustment length increments.

With further reference to the present example, after one or more of the adjustment length increments by the telescoping member 56 to adjust the telescope extension length 210, the first electric actuator 88 may be operated to perform the PIN EXTEND operation 662 to move the cylinder pins 64 to the extended position within the pin holes 68 of the T5 section, with the telescoping member 56 at the new, adjusted telescope extension length 210. The TELESCOPE ADJUST operation 672 and the PIN EXTEND operation 662 may be performed in an alternating sequence until the control system 110 determines the cylinder pins 64 are in the extended position and/or until such operations 672, 662 have been performed a predetermined number of times, for a predetermined time period, and/or over a predetermined extension length range without the control system 110 determining the cylinder pins 64 are in the extended position.

Each relatively small adjustment length increment of the telescope extension length 210 is an adjustment length, in either direction by a distance that, for example, is equal to or less than a tolerance between a width or a diameter of a cylinder pin 64 and a width or diameter of a pin hole 68 (i.e., a difference in the width or diameter of the cylinder pin 64 and the pin hole 68). Alternatively, or in addition, the adjustment length increments of the telescope extension length 210 by the telescoping member 56 may be equal to or less than a tolerance between a width of the section lock 67 that extends into the adjacent boom section 52 at the section lock hole 69, and the width of the section lock hole 69.

In some examples, the TELESCOPE ADJUST operation 672 may cause the telescoping member 56 to perform the adjustment length increments through an extension length corresponding to the extension length range in which the pinning members 64, 66 are expected to be aligned with the corresponding pinning part 68, 69 of the telescoping section 52 for the selected actuator operation. For example, the control system 110 may control the telescoping member 56 to extend in a series of adjustment length increments until the telescoping member 56 has moved through an extension length range within which the pinning members 64, 66 were expected to align with corresponding pinning parts 68, 69 of the telescoping section 52. In non-limiting examples, unless the control system 110 determines that a pinning member 64, 66 is moved to the selected position, the telescoping member 56 may continue to perform movements in the adjustment length increments in one of the extend direction or the retract direction until the telescoping member 56 reaches an extension length 210 corresponding to one limit of the extension length range 510 for the selected actuator operation. Subsequently, unless the control system 110 determines that a pinning member 64, 66 is moved to the selected position, the telescoping member 56 may be operated to perform movements in the adjustment length increments in the other of the extend or retract direction until the telescoping member 56 reaches an extension length corresponding to another limit of the extension length range 510 of the selected actuator operation.

Further, in some examples, the adjustment length increments may vary depending on the actuator operation performed. For example, the adjustment length increment may be a first adjustment length increment for a PIN RETRACT or a PIN EXTEND operation 660, 662, and may be a second adjustment length for a SECTION ARM UNLOCK or a SECTION ARM LOCK operation 664, 666.

It will be appreciated that the analogous principles, steps, comparisons and the like from the examples above may be applied in other actuator operations as well. Accordingly, the control system 110 may control the telescoping member 56 to move in adjustment length increments in one or both of the extend and retract directions, i.e., to perform the TELESCOPE ADJUST operation 672, in response to the control system 110 determining that the pinning member 64, 66 for the selected actuator operation is not in the corresponding selected position.

In the examples above in which the boom actuator 54 includes the second electric actuator 94, the control system 110 may control the second electric actuator 94 to perform one or more actuator operations in a manner similar to the control of the first electric actuator 88 in the examples above. For example, the control system 110 may provide control signals 160, 162, 164, 166 to the second electric actuator 94 to control the second electric actuator 94 to perform corresponding actuator operations 660, 662, 664, 666. It will be appreciated however, that parameter information 118 used for controlling the second electric actuator 94 may include one or more of the second length information 314, second draw information 318, second speed information 322, target second length information 414, target second draw information 418, and target second speed information 422. Accordingly, the control system 110 may control the second electric actuator 94 to move one or more of the pinning members 64, 66 to a selected position corresponding to the actuator operation performed. The TELESCOPE OPERATIONS (e.g., 670, 672, 674, 676) may be performed in the same manner as described above.

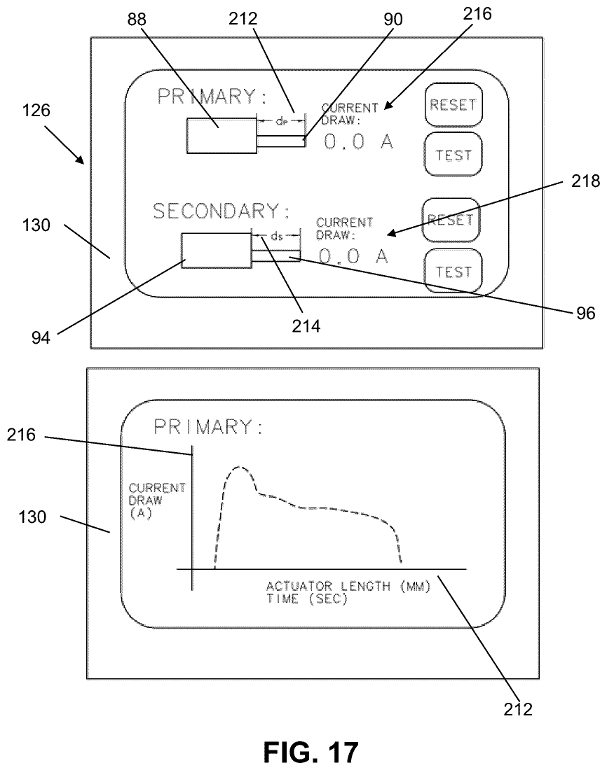

Referring to FIG. 17, in some examples, the control system 110 may be configured to output parameter information 118 via the user interface 126, for example, to the one or more user output devices 130, such as a display screen. In this manner, various performance and/or condition monitoring operations may be performed or facilitated by the control system 110. As shown in FIG. 17, according to various examples herein, the electric current draw 216, 218 may be proportional to force. The performance of the operating plate 70 may be adversely affected by issues such as mechanical misalignment and poor lubrication. The diagnostic screen 130 should allow determining the performance of the operating plate 70 and locking head 58 and preventing downtime. The graph may indicate not only that the electric current draw 216, 218 may be elevated, but also show the position of the operating plate 70 so the location of mechanical resistance during the travel could be determined.

In one example, information from the boom actuator system 54, such as the extension lengths 212, 214 of the actuators 88, 94, duty cycles, speeds and current draw may be displayed to the operator. The interface 126 may also provide means to send operator commands to the actuators 88, 94, for example, to reset the actuators 88, 94 after certain conditions are determined, e.g., an electric current draw 216, 218 exceed a current draw limit 516, 518. The interface 126 may also allow for operator commands to test the actuators 88, 94.

With further reference to FIG. 17, the user interface 126 may also display the electric current draw 216, 218 as the actuators 88, 94 are moving, which may facilitate operator monitoring of the electric current draw 216, 218 with respect to the current draw limits 516, 518. In addition, various graphical representations of the parameter information 118 may be provided. For example, a graph showing the electric current draw 216, 218 versus time or actuator extension length 212, 214 may allow for determination of a friction/alignment status pinning mechanism (i.e., the locking head 58, operating plate 70, pinning members 64, 66 and related components). For instance, an insufficient lubrication condition may be identified by the operator on such a representation by elevated levels of electric current draw 216, 218 in relation to particular actuator operations performed by the actuators 88, 94, and/or different motions or positions of the actuators 88, 94. In some examples, the parameter information 118 may be transmitted, for example, via the communication device 124 to a remote server, computing device, database and the like, and/or various combinations thereof, such that the parameter information 118 and various condition or performance monitoring operations may be conducted offsite and/or by technicians or other personnel situated remotely from the operator's cab 32 and/or crane 10.

In the examples herein, the control system 110 may be configured to monitor various aspects of the boom actuator system 54 as well. For example, the control system 110 may monitor and store information relating to the number of pinning operations or hours of actuator operation. In some examples, the parameter information 118 may include one or more of service time information relating to the length of time one or more components of the boom actuator system 54 have been in service, cycle information relating to a number of cycles or actuator operations performed by one or more components of the boom actuator system 54, and cycle time information relating to a length of time to perform an actuator operation by one or more components of the boom actuator system 54.

In some examples, the control system 110 is configured to provide one or more control signals to the boom actuator system 54 to switch performance of actuator operations from the first electric actuator 88 to the second electric actuator 94 and vice versa, based on the parameter information 118. For example, the control system 110 may provide one or more control signals to the second electric actuator 94 to perform actuator operations based on one or more of the service time information, cycle information and/or cycle time information for the first electric actuator 88. In this manner, actuator operations may be performed by the second electric actuator 94 instead of the first electric actuator 88 when the control system 110 determines that the first electric actuator 88 has been operated or in service for a predetermined length of time, performed a predetermined number of cycles (pinning operations), and/or performed actuator operations at cycle times outside of a predetermined cycle time range. The control system 110 may provide one or more control signals to the boom actuator system 54 to switch performance of actuator operations from the second electric actuator 94 back to the first electric actuator 88 based on parameter information 118 related to the second electric actuator 94 in a similar manner. It will be appreciated, however, that the various parameter thresholds or benchmarks used by the control system 110 to determine when to switch from the second electric actuator 94 to the first electric actuator 88 (e.g., predetermined length of service time, predetermined number of cycles performed, predetermined cycle performance time, etc.) may vary depending on the actuator operation performed and/or the electric actuator 88, 94 performing the operations.

The control system 110 may also be configured to monitor performance of the boom actuator system 54 and/or components of the boom actuator system 54 and determine a condition state of the boom actuator system 54 and/or one or more components of the boom actuator system based on the parameter information 118. Examples of various condition states determined by the control system 110 may include, but are not limited, one or more of a wear condition, lubrication supply, and alignment condition of pinning members 64, 66 relative to the telescoping sections 52. The control system 110 may be further configured to provide one or more notifications based on the determined condition state. Such a notification may include one or more of the determined condition state, a boom actuator system component for which the condition state is determined, a maintenance indication indicating that maintenance is due and/or a prediction of when maintenance will be due, the boom actuator system component for the maintenance indication is provided, an override indication indicating that an operator should override a boom actuator system 54 operation, and/or other similar notifications related to various condition states that may be determined by the control system 110 based on the parameter information.

In one example, the current draw for particular pinning operations (i.e., actuator operations) may be used to predict wear, insufficient lubrication, or misalignment of the pinning members 64, 66 relative to the telescoping sections 52. Benchmark information for an expected electric current draw versus an actuator position (which would be proportional to force to move the pinning mechanism, i.e., the operating plate 70 and/or the pinning members 64, 66) may also be stored by the control system 110. As the current draw is determined to exceed the benchmark information by internally stored tolerances, the control system 110 may further indicate that maintenance is needed.

As previously described, the user output device 130 may, in some examples, be provided as a display screen. The control system 110 is configured to control the user output device to provide the notification to a user. In some examples, the notification may be provided as a visual presentation based on the parameter information 118. In one example, the visual representation includes a component model of a component of the boom actuator system 54, the component model indicating at least one parameter provided by the parameter information 118. With reference to FIG. 17, the component model may be a model of the first electric actuator 88 and indicate the first extension length 212, and/or a model of the second electric actuator 94 and indicate the second extension length 214.

In another example, the visual representation includes a numerical value indicating a value of at least one parameter provided by the parameter information. In a non-limiting illustrated example, the numerical value may indicate a value of the first electric current draw 216 and/or a second electric current draw 218.

In still another example, the visual representation includes a graphical representation showing a relationship between at least two parameters provided by the parameter information 118. For example, as shown in FIG. 17, the graphical representation may show a relationship between the first electric current draw 216 and the first extension length 212 over a length of time.

In addition to the information and operations of the integrated control system 110 described herein, the control system 110 may be further configured to facilitate or perform various other operations or functions. For example, the control system 110 may include or be operably connected to manual override wiring, such that in the event of a data network being offline or damage to a cable reel, the manual override wiring can be used to send power directly to the actuators 88, 94 from the rear of the telescoping boom 36. In addition, switches may be provided for power at the actuators 88, 94. In this manner, the actuators 88, 94 may be disabled for maintenance operations. Further, the control system 110 may provide a maintenance control interface. For example, for maintenance operations and operating the telescoping boom 36 and/or boom actuator system 54 when components have failed, such an interface may be provided, for instance, at the user interface 126, and in some examples, at an output device 130 including a display screen.

In the present examples, the control system 110 and the boom actuator system 54, and components of the same, may be connected on a controller area network (CAN) bus. In further examples, the telescoping boom 36 may include one or more access points to facilitate bypass or supplemental wiring to the first and/or second electric actuators 88, 94. Accordingly, in the event control of the first and/or second electric actuators 88, 94 is interrupted on the CAN bus, the first and/or second electric actuators 88, 94 may be controlled by way of the bypass or supplemental wiring. In this manner, the boom actuator system 54 may still be operated, for example, to move the telescoping boom 36 to a predetermined position. The access points may be provided at a front (boom nose 42), rear (at a proximal or fixed end of the base section 50), or both, of the telescoping boom 36.

It is understood that various features from any of the embodiments above are usable together with the other embodiments described herein.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular. In addition, it is understood that terminology referring to orientation of various components, such as “upper” or “lower” is used for the purposes of example only, and does not limit the subject matter of the present disclosure to a particular orientation.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover all such modifications as fall within the scope of the claims.

What is claimed is:

1. A crane comprising:
a carrier;
a superstructure mounted on the carrier, the superstructure comprising a telescoping boom having a base section and a plurality of telescoping sections;
a boom actuator system comprising a telescoping member and a locking head on the telescoping member, the locking head having pinning members configured to selectively interact with the telescoping sections; and
a control system configured to receive parameter information relating to the boom actuator system and to control the boom actuator system to perform an actuator operation using the parameter information, wherein the actuator operation is an operation to move a pinning member of the pinning members to a selected position,
wherein the control system is configured to determine whether the pinning member is in the selected position using the parameter information, and
wherein the control system is configured to control the boom actuator system to perform an actuator operation to adjust the telescoping member in the length direction if the control system determines that the pinning member is not in the selected position.

2. The crane of claim 1, wherein the boom actuator system further comprises:
a first electric actuator having a first drive arm movable in response to operation of the first electric actuator; and
an operating plate movable relative to the locking head along a movement axis, the operating plate configured to interact with the pinning member such that movement of the operating plate along the movement axis causes movement of the pinning member,
wherein the first drive arm is operably connected to the operating plate such that movement of the first drive arm causes movement of the operating plate along the movement axis.

3. The crane of claim 2, wherein the parameter information includes:
first length information relating to a first extension length of the first drive arm;
target first length information relating to a known first extension length of the first drive arm corresponding to the selected position of the pinning member;
first speed information relating to a first speed of the first electric actuator;
target first speed information relating to a first configuration speed of the first electric actuator;
first draw information relating to a first electric current draw of the first electric actuator; and
target first draw information relating to a first electric current draw limit of the first electric actuator during the actuator operation to move the pinning member.

4. The crane of claim 3, wherein the control system determines the pinning member is not in the selected position if the first length information is not equal to the target first length information for the actuator operation or the first draw information is greater than the target first draw information for the actuator operation, and
wherein the control system determines the pinning member is in the selected position if the first length information is equal to the target first length information for the actuator operation and the first draw information is less than the target first draw information for the actuator operation.

5. The crane of claim 4, wherein the pinning members include one or more cylinder pins configured for movement between an extended position and a retracted position and one or more section lock arms configured for movement between a locking position and an unlocking position.

6. The crane of claim 5, wherein the pinning member is the one or more cylinder pins and the selected position is one of the extended position and the retracted position.

7. The crane of claim 5, wherein the pinning member is the one or more section lock arms and the selected position is one of the locking position and the unlocking position.

8. The crane of claim 3, further comprising a second electric actuator having a second drive arm connected to the first electric actuator.

9. The crane of claim 8, wherein the parameter information further includes:
second extension information relating to a second extension length of the second drive arm; and
target second length information relating to a known second extension length of the second drive arm corresponding to the selected position of the pinning member.

10. The crane of claim 3, wherein the parameter information further includes one or more of:
service time information relating to a length of time one or more components of the boom actuator system have been in service,
cycle information relating to a number of cycles performed by one or more components of the boom actuator system, and
cycle time information relating to a length of time to perform an actuator operation by one or more components of the boom actuator system,
wherein the control system is configured to determine a condition state of one or more components of the boom actuator system based on one or more of the service time information, cycle information, and the cycle time information, and
wherein the condition state includes one or more of a predicted wear, a lubrication level, maintenance due, and remaining service life.

11. The crane of claim 8, wherein the parameter information further includes one or more of:
service time information relating to the length of time components of the boom actuator system have been in service,
cycle information relating to a number of cycles performed by one or more components of the boom actuator system, and
cycle time information relating to a length of time components of the boom actuator system use to perform an actuator operation.

12. The crane of claim 11, wherein the control system is configured to control the second electric actuator to perform an actuator operation based on one or more of the service time information, cycle information, and cycle time information.

13. A boom actuator system comprising:
a telescoping member configured for telescoping movement to extend and retract in a length direction;
a locking head on the telescoping member, the locking head having pinning members configured to selectively interact with telescoping sections of a telescoping boom;
a first electric actuator having a first drive arm movable in response to operation of the first electric actuator to perform an actuator operation;
an operating plate movable relative to the locking head along a movement axis, the operating plate configured to interact with the pinning members such that movement of the operating plate along the movement axis causes movement of the pinning members, wherein the operating plate is operably coupled to first drive arm and is movable along the movement axis in response to movement of the first drive arm; and
a control system configured to receive parameter information relating to first electric actuator and to control the first electric actuator to perform the actuator operation to move a pinning member of the pinning members to a selected position,
wherein the control system is configured to determine whether the pinning member is in the selected position using the parameter information, and
wherein the control system is configured to control the telescoping member to perform an actuator operation to adjust the position of the locking head in the length direction if the control system determines that the pinning member is not in the selected position.

14. The boom actuator system of claim 13, wherein the parameter information includes first length information relating to an extension length of the first drive arm, target first length information relating to a known extension length of the first drive arm corresponding to the selected position of the pinning member for the actuator operation, first draw information relating to an electric current draw of the first electric actuator and target first draw information relating to an electric current draw limit of the first electric actuator for the actuator operation.

15. The boom actuator system of claim 14, wherein the control system determines the pinning member is not in the selected position if the first length information is not equal to the target first length information for the actuator operation or the first draw information is greater than the target first draw information for the actuator operation, and
wherein the control system determines the pinning member is in selected position if the first length information is equal to the target first length information for the actuator operation and the first draw information is less than the target first draw information for the actuator operation.

16. A control system for controlling a boom actuator system to perform an actuator operation, the boom actuator system comprising a telescoping member and a locking head on the telescoping member, the locking head having pinning members configured to selectively interact with telescoping sections of a telescoping boom, the control system comprising a processing unit and one or more memory devices configured to store program instructions which when executed by the processing unit cause the control system to:
receive parameter information relating to parameters of the boom actuator system;
provide a control signal to the boom actuator system to control the boom actuator system to perform an actuator operation to move a pinning member of the pinning members to a selected position using the parameter information;
determine whether the pinning member is in the selected position using the parameter information, and
control the boom actuator system to perform an actuator operation to adjust the telescoping member in the length direction if the pinning member is not in the selected position.

17. The control system of claim 16, wherein the boom actuator system further comprises a first electric actuator having a first drive arm movable in response to operation of the first electric actuator; and
an operating plate operably coupled to the first drive arm movable relative to the locking head along a movement axis, the operating plate configured to interact with the pinning member such that movement of the operating plate along the movement axis causes movement of the pinning member,
wherein the control signal controls the first electric actuator to perform the actuator operation by moving the first drive arm to cause movement of the operating plate.

18. The control system of claim 17, wherein the pinning members include one or more cylinder pins movable between an extended position and a retracted position and one or more section lock arms movable between a locking position and an unlocking position,
wherein the control signal is one or more of:
a PIN RETRACT control signal for controlling the first electric actuator to perform an actuator operation in which the pinning member is the cylinder pins and the selected position is the retracted position;
a PIN EXTEND control signal for controlling the first electric actuator to perform an actuator operation in which the pinning member is the cylinder pins and the selected position is the extended position;
a SECTION ARM UNLOCK control signal for controlling the first electric actuator to perform an actuator operation in which the pinning member is the section lock arms and the selected position is the unlocking position; and
a SECTION ARM LOCK control signal for controlling the first electric actuator to perform an actuator operation in which the pinning member is the section lock arms and the selected position is the locking position.

19. The control system of claim 18, wherein the control signal further includes one or more of:
a TELESCOPE EXTEND control signal for controlling the telescoping member to perform an actuator operation in which a slide part of the telescoping member is extended relative to a base part of the telescoping member to extend a telescoping section to a selected extension position;
a TELESCOPE RETRACT control signal for controlling the telescoping member to perform an actuator operation in which the slide part is retracted relative to the base part to retract a telescoping section to a selected extension position;
a TELESCOPE REPOSITION control signal for controlling the telescoping member to perform an actuator operation in which the slide part is moved relative to the base part to reposition the locking head adjacent to pin holes of a telescoping section to be moved; and
a TELESCOPE ADJUST control signal for controlling the telescoping member to perform an actuator operation in which the slide part is moved in a series of extend and retract movements to adjust a position of the pinning member relative to a telescoping section.

20. The control system of claim 17, wherein the parameter information includes first length information relating to an extension length of the first drive arm, target first length information relating to a known extension length of the first drive arm corresponding to the selected position of the pinning member, first draw information relating to an electric current draw of the first electric actuator and target first draw information relating to an electric current draw limit of the first electric actuator during the actuator operation, speed information relating to a speed of the first drive arm, and target first speed information relating to a speed limit of the first drive arm during the actuator operation.
